(19) United States
(12) Patent Application Publication
(10) Pub. No.: US 2024/0367855 A1
(43) Pub. Date: Nov. 7, 2024

(54) CONTAINER, ASSEMBLIES, AND METHODS FOR OPERATING THE SAME

(71) Applicant: Sauder Woodworking Co., Archbold, OH (US)

(72) Inventors: Neal Fifer, McClure, OH (US); Nolan Masters, Waldron, MI (US)

(21) Appl. No.: 18/650,316

(22) Filed: Apr. 30, 2024

Related U.S. Application Data
(60) Provisional application No. 63/499,369, filed on May 1, 2023.

(51) Int. Cl. B65D 21/08

(52) U.S. Cl. CPC B65D 21/08

(57) ABSTRACT

A container is disclosed. The container includes a base portion and a support portion. The support portion is movably-connected to the base portion. Each of the base portion and the support portion include a plurality of panels and members. The support portion includes an item retaining barrier. The base portion forms a support portion receiving cavity configured for receiving the support portion. An assembly is also disclosed. The assembly includes a container and at least one item.

### CROSS REFERENCE TO RELATED APPLICATION

This application claims priority to U.S. Ser. No. 63/499,369, filed May 1, 2023. The entire contents of the aforementioned application are incorporated herein.

### TECHNICAL FIELD

The present disclosure relates generally to a container, assemblies, and methods of operating the same.

### BACKGROUND

This section provides background information related to the present disclosure and is not necessarily prior art.

While known containers and assemblies have proven to be acceptable for various applications, containers and assemblies are nevertheless susceptible to improvements that may enhance their overall performance and cost. Therefore, a need exists to develop improved containers and assemblies that advance the art.

### SUMMARY

This section provides a general summary of the disclosure, and is not a comprehensive disclosure of its full scope or all of its features.

One aspect of the disclosure provides a container. The container includes a base portion and a support portion. The support portion is movably-connected to the base portion. Each of the base portion and the support portion include a plurality of panels and members. The support portion includes an item retaining barrier. The base portion forms a support portion receiving cavity configured for receiving the support portion.

Implementations of the disclosure may include one or more of the following optional features. The plurality of panels and members forming the base portion include at least a first leg member, a second leg member, and a shelf panel. The first leg member, the second leg member, and the shelf panel form the support portion receiving cavity.

In some examples, a first side surface of the shelf panel is secured to an inner side surface of the first leg member. A second side surface of the shelf panel is secured to an inner side surface of the second leg member. The support portion receiving cavity is formed by: a lower side surface of the shelf panel; a portion of the inner side surface of the first leg member extending away from the lower side surface of the shelf panel; and a portion of the inner side surface of the second leg member extending away from the lower side surface of the shelf panel.

In other examples, the plurality of panels and members forming the base portion further includes a roof panel. An upper surface of the first leg member is secured to a lower surface of the roof panel near a first side surface of the roof panel. An upper surface of the second leg member is secured to the lower surface of the roof panel near a second side surface of the roof panel that is opposite the first side surface of the roof panel.

In yet other examples, the plurality of panels and members forming the support portion include at least a support panel and at least one panel that forms the item retaining barrier connected to and extending from an inner surface of the support panel at a height. The at least one panel that forms the item retaining barrier includes: a first side panel having a lower surface that is secured to the inner surface of the support panel near a first side surface of the support panel; a second side panel having a lower surface that is secured to the inner surface of the support panel near a second side surface of the support panel; a first end panel having a lower surface that is secured to the inner surface of the support panel near a third side surface of the support panel; a second end panel having a lower surface that is secured to the inner surface of the support panel near a fourth side surface of the support panel. The second side surface of the support panel is opposite the first side surface of the support panel. The third side surface of the support panel is connected to a first end of the first side surface of the support panel and a first end of the second side surface of the support panel. The fourth side surface of the support panel is opposite the third side surface of the support panel. The fourth side surface of the support panel is connected to a second end of the first side surface of the support panel and a second end of the second side surface of the support panel.

In further examples, the container also includes a first pivot pin and a second pivot pin that rotatably-connect the support portion to the base portion for permitting the support portion to be arranged in one of: a stowed orientation relative the base portion; and a deployed orientation relative the base portion. The first pivot pin extends through and is arranged within: a pivot pin passage formed near a lower end of a member of the plurality of panels and members of the base portion; and a pivot pin passage formed near a lower end of a panel of the plurality of panels and members of the support portion. The second pivot pin extends through and is arranged within: a pivot pin passage formed near a lower end of another member of the plurality of panels and members of the base portion; and a pivot pin passage formed near a lower end of another panel of the plurality of panels and members of the support portion.

In another example, the container also includes at least one damper connected to one or both of the base portion and the support portion. The at least one damper is arranged for one or both of: resisting movement of the support portion relative the base portion in a first direction; and assisting movement of the support portion relative the base portion in a second direction opposite the first direction.

In yet another example, the damper includes a first portion and a second portion. The first portion of the damper includes a hydraulic arm, a first wheel guide track, and a second wheel guide track. The second portion of the damper includes a first bracket-mounted wheel, a second bracket-mounted wheel, and a hydraulic arm bracket.

In some examples, the hydraulic arm includes: a first end connected to the base portion; a first wheel guide track connected to the base portion; and a second wheel guide track connected to the base portion. In other examples, the second wheel guide track is arranged substantially perpendicularly with respect to the first wheel guide track.

In other examples, the first bracket-mounted wheel is connected to the support portion. The first bracket-mounted wheel is movably-disposed within the first wheel guide track of the first portion of the damper. The second bracket-mounted wheel is connected to the support portion. The second bracket-mounted wheel is movably-disposed within the second wheel guide track of the first portion of the damper. The hydraulic arm bracket is connected to the support portion. The hydraulic arm bracket is connected to a second end of the hydraulic arm of the first portion of the damper.

In further examples, the first bracket-mounted wheel is movably-disposed within first wheel guide track in a first direction. The second bracket-mounted wheel is movably-disposed within second wheel guide track in a second direction. The first direction is substantially perpendicular to the second direction.

Another aspect of the disclosure provides an assembly. The assembly includes a container and at least one item. The container includes a base portion and a support portion. The support portion is movably-connected to the base portion. Each of the base portion and the support portion include a plurality of panels and members. The support portion includes an item retaining barrier. The base portion forms a support portion receiving cavity configured for receiving the support portion. The at least one item is supported by the support portion and retained by the item retaining barrier.

Implementations of the disclosure may include one or more of the following optional features. The at least one item is a pillow. The pillow is defined by a thickness extending between a top surface of the pillow and a bottom surface of the pillow. The item retaining barrier of the support portion is defined by a height dimension that is approximately equal to the thickness of the pillow.

In some implementations, the at least one item is a knock-down housing. The knock-down housing is defined by a collapsed orientation height. The item retaining barrier of the support portion is defined by a height dimension that is approximately equal to the collapsed orientation height of the knock-down housing.

In other implementations, the knock-down housing is defined by an expanded orientation height. The height dimension of the item retaining barrier that is less than the expanded orientation height of the knock-down housing.

In yet other implementations, the at least one item further includes a pan interfaced with the knock-down housing. The at least one item further includes a pillow interfaced with the knock-down housing.

### DESCRIPTION OF DRAWINGS

In order to describe the manner in which the above-recited and other advantages and features of the present disclosure can be obtained, a more particular description of the present disclosure briefly described above will be rendered by reference to specific embodiments thereof which are illustrated in the appended drawings. Understanding that these drawings depict only typical embodiments of the present disclosure and are not therefore to be considered to be limiting of its scope, the present disclosure will be described and explained with additional specificity and detail through the use of the accompanying drawings in which:

FIG. 1 is a perspective view of a container including a base portion and a support portion arranged in a stowed orientation relative to the base portion, according to the principles of the present disclosure.

FIG. 2 is another perspective view of the container of FIG. 1 including the support portion arranged a deployed orientation relative to the base portion.

FIG. 3 is a front exploded view of the container of FIG. 1.

FIG. 4 is a rear perspective view of the container of FIG. 1.

FIG. 5 is a rear exploded view of the container of FIG. 4.

FIG. 6 is an enlarged perspective view of a portion of the container of FIG. 1.

FIG. 7 is another enlarged perspective view of a portion of the container of FIG. 1.

FIG. 8 is another enlarged perspective view of a portion of the container of FIG. 1.

FIG. 9 is another enlarged perspective view of a portion of the container of FIG. 1.

FIG. 10 is another enlarged perspective view of a portion of the container of FIG. 1.

FIG. 11 is another rear perspective view of the container of FIG. 1.

FIG. 12 is a side view of the container of FIG. 1.

FIG. 13 is an enlarged view of the container of FIG. 12.

FIG. 14 is a perspective view of a damper of the container of FIG. 1.

FIG. 15 is a perspective view of a first assembly including a first item and the container of FIG. 1 whereby the support portion is shown arranged in the deployed orientation relative to the base portion and the first item is sized for arrangement upon the support portion.

FIG. 16A is a perspective view of a second item being partially arranged within a third item that is sized for arrangement upon the support portion of the container whereby an access door of the third item is arranged in an open orientation.

FIG. 16B is a perspective view of the second item being arranged within the third item that is sized for arrangement upon the support portion of the container whereby the access door of the third item is arranged in a closed orientation.

FIG. 17 is a perspective view of a second assembly including the second item, the third item, and the container of FIG. 1 whereby the support portion is shown arranged in the deployed orientation relative to the base portion and the second item and the third item are sized for arrangement upon the support portion.

FIG. 18 is a perspective view of a third assembly including the second item, the third item, a fourth item, and the container of FIG. 1 whereby the support portion is shown arranged in the deployed orientation relative to the base portion and the second item, the third item, and the fourth item are sized for arrangement upon the support portion.

FIG. 19 is a perspective view of another container including a base portion and a support portion arranged in a stowed orientation relative to the base portion, according to the principles of the present disclosure.

FIG. 20 is another perspective view of the container of FIG. 19 including the support portion arranged a deployed orientation relative to the base portion.

FIG. 21 is a perspective view of a portion of the container of FIG. 20 that does not include the support portion.

FIG. 22 is a perspective view of another portion of the container of FIG. 20 that does not include the base portion.

FIG. 23 is a side view of the container of FIG. 20 including the support portion arranged in the deployed orientation relative to the base portion.

FIG. 23A is a side view of the container of FIG. 20 including the support portion arranged in the deployed orientation relative to the base portion.

FIG. 23B is another side view of the container according to FIG. 23A including the support portion transitioned from the deployed orientation to a partially stowed orientation relative the base portion.

FIG. 23C is another side view of the container according to FIG. 23B including the support portion further transitioned from the partially stowed orientation relative the base portion to a further partially stowed orientation relative the base portion.

FIG. 23D is another side view of the container according to FIG. 23C including the support portion further transitioned from the further partially stowed orientation relative the base portion to an even further partially stowed orientation relative the base portion.

FIG. 23E is another side view of the container according to FIG. 23D including the support portion further transitioned from the even further partially stowed orientation relative the base portion to a yet even further partially stowed orientation relative the base portion.

FIG. 23F is another side view of the container according to FIG. 23E including the support portion further transitioned from the yet even further partially stowed orientation relative the base portion to the stowed orientation relative the base portion of FIG. 19.

FIG. 24 is a perspective view of a cam lock nut.

FIG. 25 is a perspective view of a cam screw.

FIG. 26 is an exemplary partially exploded perspective view of a first member/panel including a pair of cam lock nuts and a second member/panel including a pair of cam screws.

FIG. 27 is an exemplary assembled perspective, partial cut-away view of a first member/panel including a cam lock nut connected to a second member/panel including a cam screw.

Corresponding reference numerals indicate corresponding parts throughout the drawings.

### DETAILED DESCRIPTION

The present disclosure relates generally to a container, assemblies, and methods for operating the same. In some instances, a support portion of the container is arranged in a deployed orientation relative a base portion of the container for supporting one item or a plurality of items. Furthermore, the item may be contained within the container when the support portion of the container is arranged in a stowed orientation relative the base portion of the container. An assembly is formed when one or more items are supported by the support portion of the container.

Embodiments of the present disclosure provide technical solutions to a number of technical problems in the art.

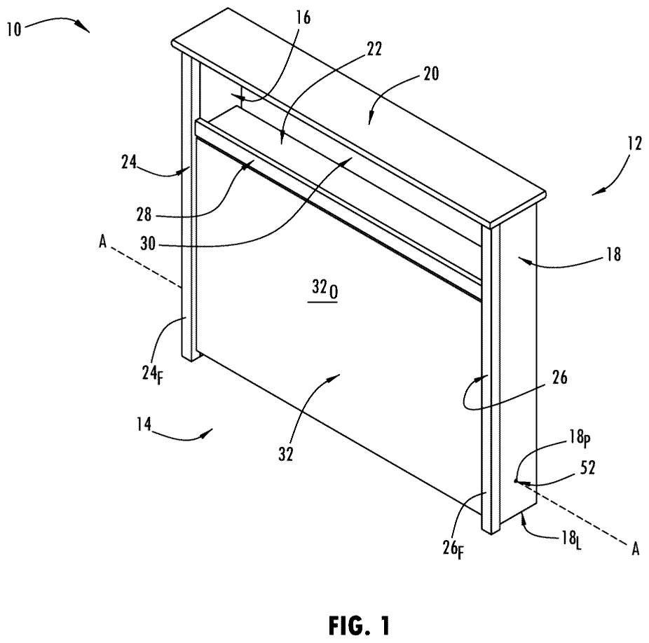

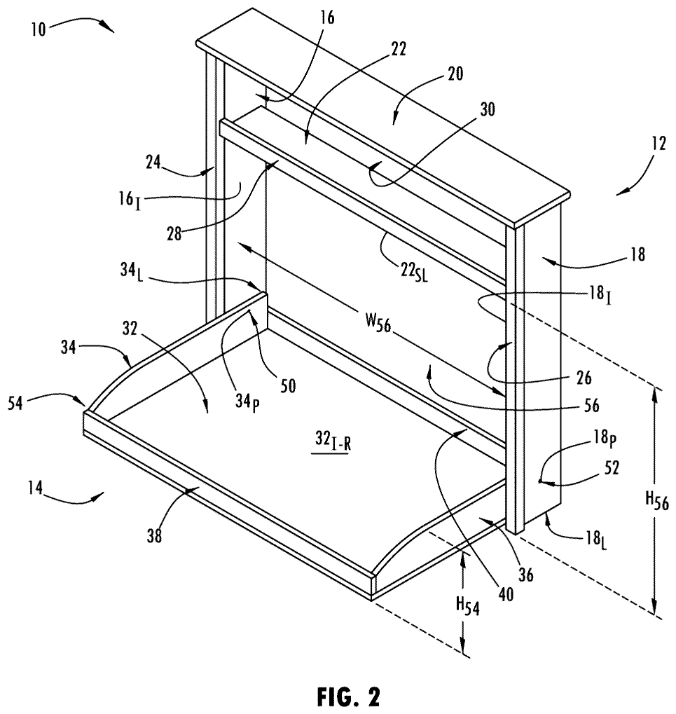

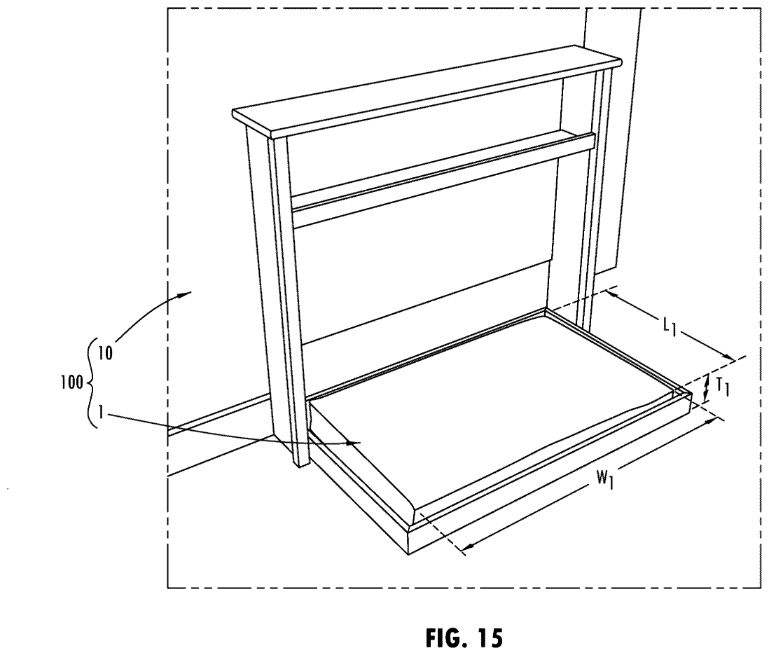

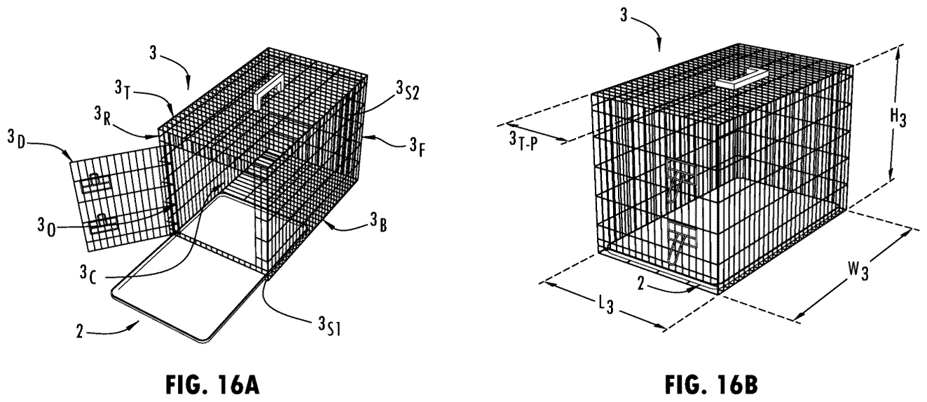

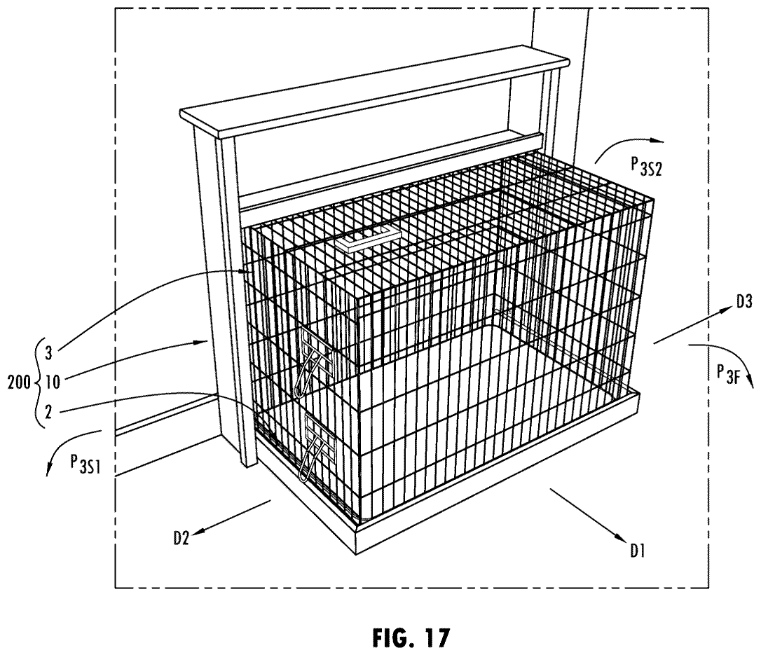

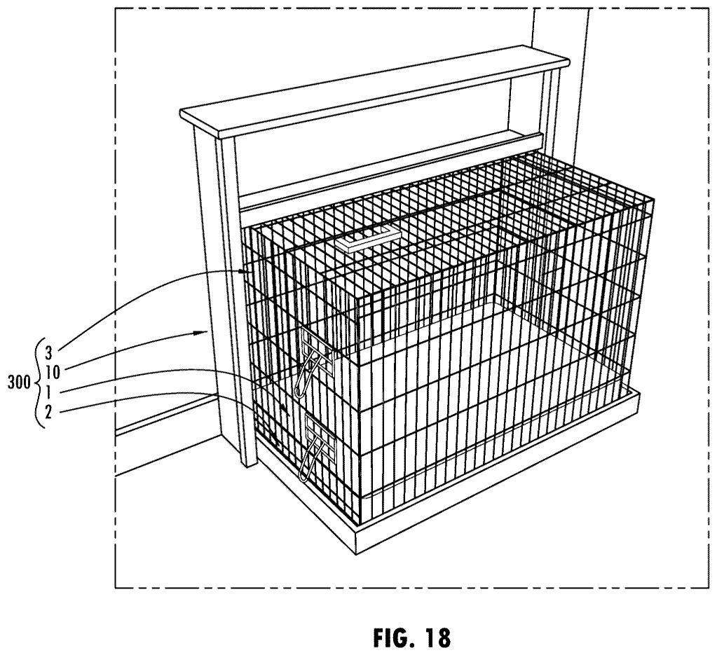

Implementations of the present disclosure relate generally to a container 10 (see, e.g., FIGS. 1-2). The container 10 includes a base portion 12 and a support portion 14. The support portion 14 is arrangable relative the base portion 12 in: (1) a stowed orientation (see, e.g., FIG. 1); an intermediate orientation (not shown); or a deployed orientation (see, e.g., FIG. 2). The support portion 14 is sized for supporting one item 1 (see, e.g., FIG. 15) or a plurality of items 2, 3, 4 (see, e.g., FIGS. 16A-18). Furthermore, as seen at FIGS. 15 and 17-18 the one or more items 1, 2, 3 may be contained within the container 10 when the support portion 14 of the container 10 is arranged in a stowed orientation relative the base portion 12 of the container 10. As seen respectively at, for example, FIGS. 15, 17, and 18, an assembly 100 (see, e.g., FIG. 15), 200 (see, e.g., FIG. 17), 300 (see, e.g., FIG. 18) is formed when the one or more items 1, 2, 3 is/are supported by the support portion 14 of the container 10.

The assemblies 100, 200, 300 provide a plurality of functions or intended uses. In some implementations, each assembly 100, 200, 300 may be sized for providing a rest area or housing for animalia (not shown, e.g., a dog, a cat).

In a first example, as seen at FIG. 15, the item 1 of the assembly 100 may include a pillow that is sized for arrangement upon the support portion 14 of the container 10. The pillow 1 may provide a rest area whereby the animalia (not shown) is free to rest upon or leave the assembly 100 at its convenience. Furthermore, in some configurations, the pillow 1 may be contained within the container 10 when the support portion 14 is arranged in a stowed orientation relative the base portion 12.

With reference to FIGS. 16A-16B, the items 2, 3 associated with the assembly 200 or the assembly 200 may respectively include a pan (see, e.g., reference numeral 2 at FIG. 16A) and a housing (see, e.g., reference numeral 3 at FIGS. 16A-16B). The housing 3 may be in the form of, for example, a knock-down kennel/a knock-down cage, or the like. The housing/knock-down kennel/a knock-down cage 3 may include a plurality of panels 3_{F}, 3_{T}, 3_{R}, 3_{S1}, 3_{S2}, 3_{B} that may be arranged in: (1) a collapsed or substantially flat orientation (not shown); (2) a partially deployed or non-flat orientation (not shown); or (3) an expanded orientation (see, e.g., FIGS. 16A-16B, 17, 18).

In another example, as seen at FIG. 17, items 2, 3 are sized for arrangement upon the support portion 14 of the container 10. The plurality of panels 3_{F}, 3_{T}, 3_{R}, 3_{S1}, 3_{S2}, 3_{B} of the housing/knock-down kennel/a knock-down cage define a cavity 3_{C} (see, e.g., FIG. 16A). Access to the cavity 3_{C} is permitted by one or more openings 3_{O} (see, e.g., FIG. 16A) formed by the one or more panels 3_{F}, 3_{T}, 3_{R}, 3_{S1}, 3_{S2}. A door 3_{D} (see, e.g., FIG. 16A) is attached to one or more of the panels 3_{F}, 3_{T}, 3_{R}, 3_{S1}, 3_{S2} and is arrangable in one of a closed orientation (see, e.g., FIG. 16B) and an open orientation (see, e.g., FIG. 16A) in order to respectively deny access to or permit access to the one or more openings 3_{O}. The cavity 3_{C} of the housing 3 may provide a rest area whereby the animalia (not shown) may optionally not be free to leave the assembly 200 at its convenience depending on the closed orientation of the door 3_{D} or the open orientation of the door 3_{D}. When the door 3_{D} is in the open orientation, the animalia may enter or exit the cavity 3_{C} of the housing 3 by way of the one or more openings 3_{O}. When the door 3_{D} is in the closed orientation, the animalia may not enter or exit the cavity 3_{C} of the housing 3 by way of the one or more openings 3_{O}. The pan 2 may be selectively interfaced with a panel 3_{B} of the housing 3 (see, e.g., FIGS. 16A-16B) prior to arrangement of the housing 3 upon the support portion 14 of the container 10. The pan 2 may contain or capture, for example: food, water, urine, feces, vomit, or other bodily fluids. Furthermore, in some configurations, the pan 2 and the housing 3 may be contained within the container 10 when the support portion 14 is arranged in a stowed orientation relative the base portion 12; however, prior to arranging the support portion 14 in the stowed orientation relative the base portion 12, the housing 3 should be arranged in a collapsed orientation (not shown).

In yet another example, as seen at FIG. 18, the items 1, 2, 3 of the assembly 300 may respectively include a pillow, a pan, and a housing (e.g., a kennel or cage) that is sized for arrangement upon the support portion 14 of the container 10. The housing 3 includes a plurality of panels 3_{F}, 3_{T}, 3_{R}, 3_{S1}, 3_{S2}, 3_{B} that define a cavity 3_{C}. Access to the cavity 3_{C} is permitted by one or more openings 3_{O} (see, e.g., FIG. 16A) formed by the one or more panels 3_{F}, 3_{T}, 3_{R}, 3_{S1}, 3_{S2}. A door 3_{D} (see, e.g., FIG. 16A) is attached to one or more of the panels 3_{F}, 3_{T}, 3_{R}, 3_{S1}, 3_{S2} and is arrangable in one of a closed orientation (see, e.g., FIG. 16B) and an open orientation (see, e.g., FIG. 16A) in order to respectively deny access to or permit access to the one or more openings 3_{O}. When the door 3_{D} is arranged in an open orientation (see, e.g., FIG. 16A), the pillow 1 may be inserted through the opening 3_{O} (see, e.g., FIG. 16A) for arrangement within the cavity 3_{C} of the housing 3 and upon the panel 3_{B} (see, e.g., FIG. 18) of the housing 3. The cavity 3_{C} of the housing 3 may provide a rest area whereby the animalia may not be free to leave the assembly 300 at its convenience depending on the closed orientation of the door 3_{D} or the open orientation of the door 3_{D}. When the door 3_{D} is in the open orientation, the animalia may enter or exit the cavity 3_{C} of the housing 3 by way of the one or more openings 3_{O}. When the door 3_{D} is in the closed orientation, the animalia may not enter or exit the cavity 3_{C} of the housing 3 by way of the one or more openings 3_{O}. The pan 2 may be selectively interfaced with a panel 3_{B} of the housing 3 (as seen at, e.g., FIGS. 16A-16B) prior to arrangement of the housing 3 upon the support portion 14 of the container 10. The pan 2 may contain or capture, for example: food, water, urine, feces, vomit, or other bodily fluids. Furthermore, in some configurations, the pan 2 and the housing 3 may be contained within the container 10 when the support portion 14 is arranged in a stowed orientation relative the base portion 12; however, prior to arranging the support portion 14 in the stowed orientation relative the base portion 12: (1) the pillow 1 should be removed from the cavity 3c of the housing 3; and (2) the housing 3 should be arranged in a collapsed orientation (not shown).

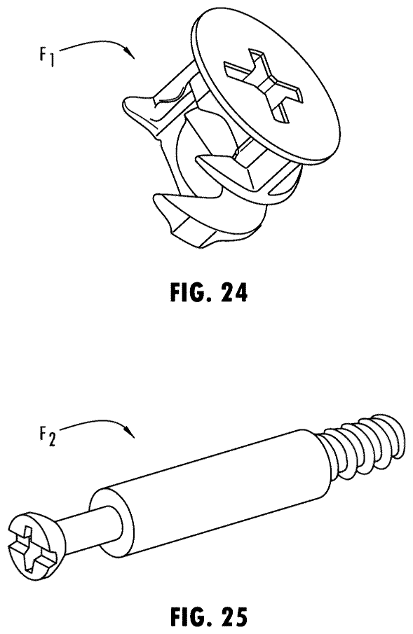

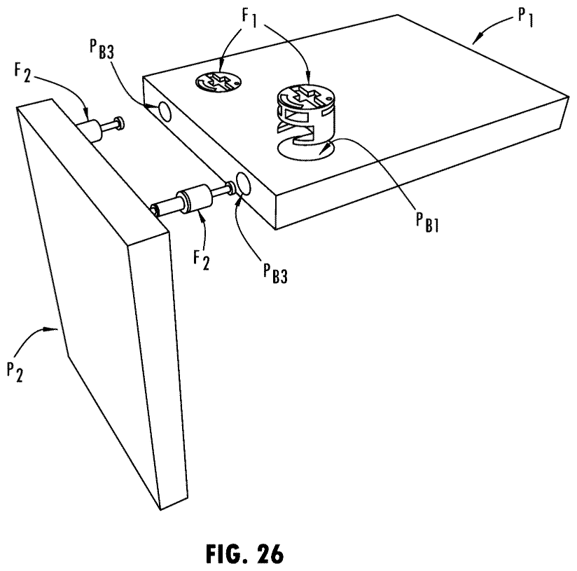

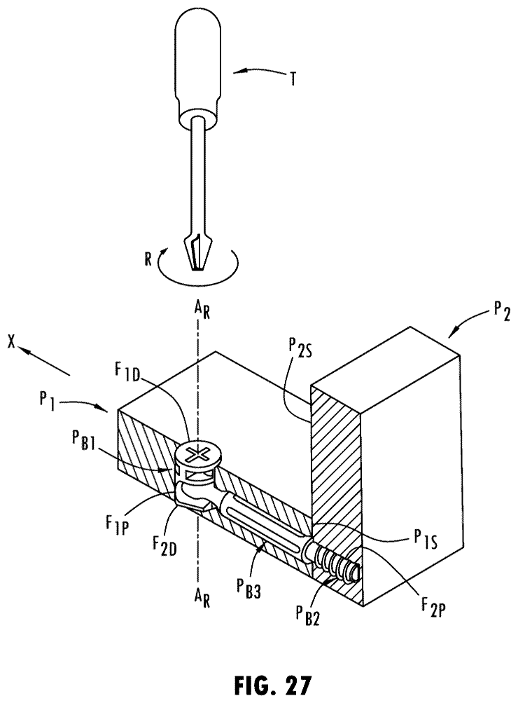

Referring now to FIGS. 1-2, an exemplary configuration of the base portion 12 of the container 10 is described. The base portion 12 includes a first leg member 16, a second leg member 18, a roof panel 20, and a shelf panel 22. The base portion 12 may also optionally include: a first leg member trim panel 24; a second leg member trim panel 26; a shelf trim panel 28; and a rear trim panel 30. The members and panels 16-30 that form the base portion 12 may be connected with one or more fasteners (e.g., dowels, nails, screws, washers), adhesive, or the like; in some examples, the one or more fasteners may include one or more cam lock nuts F₁ (see, e.g., FIG. 24) and one or more cam screws F₂ (see, e.g., FIG. 25) for joining a first panel P₁ (see, e.g., FIGS. 26-27) of the members and panels 16-30 that form the base portion 12 to a second panel P₂ (see, e.g., FIGS. 26-27) of the members and panels 16-30 that form the base portion 12. As such, the base portion 12 may be a ready-to-assemble (RTA) furniture component that may be assembled by a user rather than assembled by a furniture manufacturer.

If one or more cam nuts F₁ and one or more cam screws F₂ are utilized for assembling the base portion 12, the base portion 12 may be assembled as follows. For example, as seen at FIG. 26, a cam nut F₁ may be rotatably-disposed within a cam nut-receiving bore P_{B1} of a first member/panel P₁ of the members/panels 16-30 of the base portion 12, and a cam screw F₂ may be threadingly-secured within a threaded bore P_{B2} (see, e.g., FIG. 27) formed by a second member/panel P₂ of the members/panels 16-30 of the base portion 12. In order to connect the first member/panel P₁ (that includes the one or more cam nuts F₁) to the second member/panel P₂ (that includes the one or more cam screws F₂), the cam screw F₂ is axially-aligned with (see, e.g., FIG. 26) a cam nut bore access passageway bore P_{B3} (see, e.g., FIG. 26) that is formed by the first member/panel P₁ and then the cam screw F₂ is inserted into (see, e.g., FIG. 27) the cam nut bore access passageway bore P_{B3}. As seen at FIGS. 26-27, the cam nut bore access passageway bore P_{B3} is substantially perpendicular with respect to the cam nut-receiving bore P_{B1}. Then, as seen at FIG. 27, once a distal end F_{2D} of the cam screw F₂ is interfaced with a proximal end F_{1P} of the cam nut F₁, a user utilizes a tool T (see, e.g., FIG. 27), such as, a screwdriver, in order to engage a distal end F_{1D} of the cam nut F₁ to rotate R the cam nut F₁. Rotation R of the cam nut F₁ results in the application of a pulling force or a drawing force X (that is orthogonal to a rotational axis A_{R}-A_{R} of the cam nut F₁) applied to the cam screw F₂. As a result, because a proximal end F_{2P} of the cam screw F₂ is threadingly-secured to the second panel P₂, an outer surface P_{2S} of the second panel P₂ (where the cam screw F₂ extends therefrom) is drawn into close or tight engagement with an outer surface P_{1S} of the first panel P₁ (that provides access to the cam nut bore access passageway bore P_{B3}).

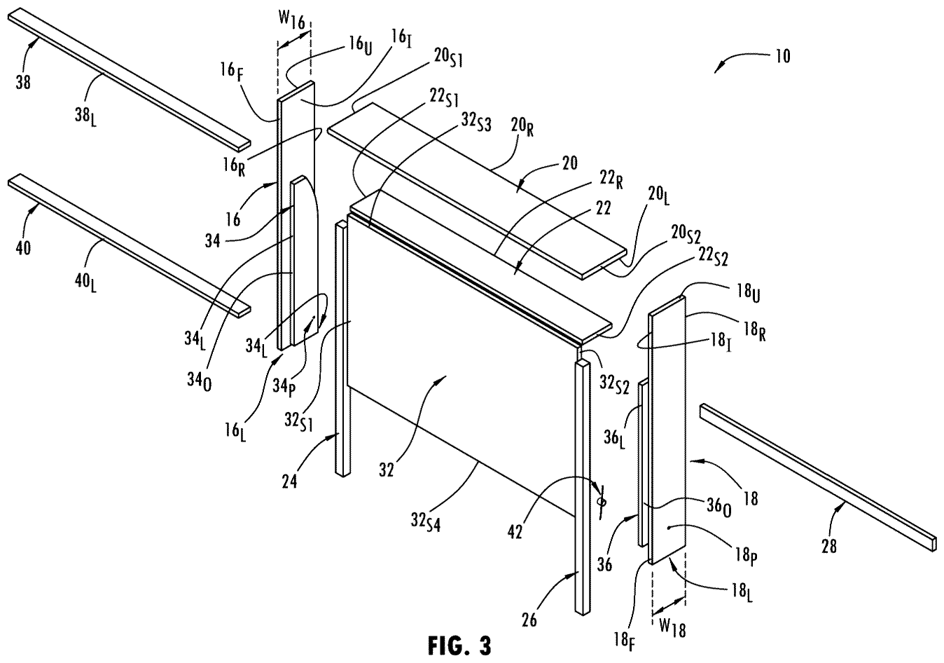

Referring to FIG. 3, an exemplary connection arrangement of the members/panels 16-30 of the base portion 12 is now described. A first side surface 22_{S1} of the shelf panel 22 is secured to an inner side surface 16_{I} of the first leg member 16. A second side surface 22_{S2} of the shelf panel 22 (that is opposite the first side surface 22_{S1} of the shelf panel 22) is secured to an inner side surface 18_{I} of the second leg member 18. An upper surface 16_{U} of the first leg member 16 is secured to a lower surface 20_{L} of the roof panel 20 near a first side surface 20_{S1} of the roof panel 20. An upper surface 18_{U} of the second leg member 18 is secured to the lower surface 20_{L} of the roof panel 20 near a second side surface 20_{S2} of the roof panel 20 (that is opposite the first side surface 20_{S1} of the roof panel 20).

The optional first leg member trim panel 24 may be optionally-secured to a front surface 16_{F} of the first leg member 16. The optional second leg member trim panel 26 may be optionally-secured to a front surface 18_{F} of the second leg member 18. The optional shelf trim panel 28 may be optionally-secured to a front surface 18_{F} of the shelf panel 22. The optional rear trim panel 30 may be secured to one or more of: a rear surface 16_{R} of the first leg member 16; a rear surface 18_{R} of the second leg member 18; a rear surface 20_{R} of the roof panel 20; and a rear surface 22_{R} of the shelf panel 22.

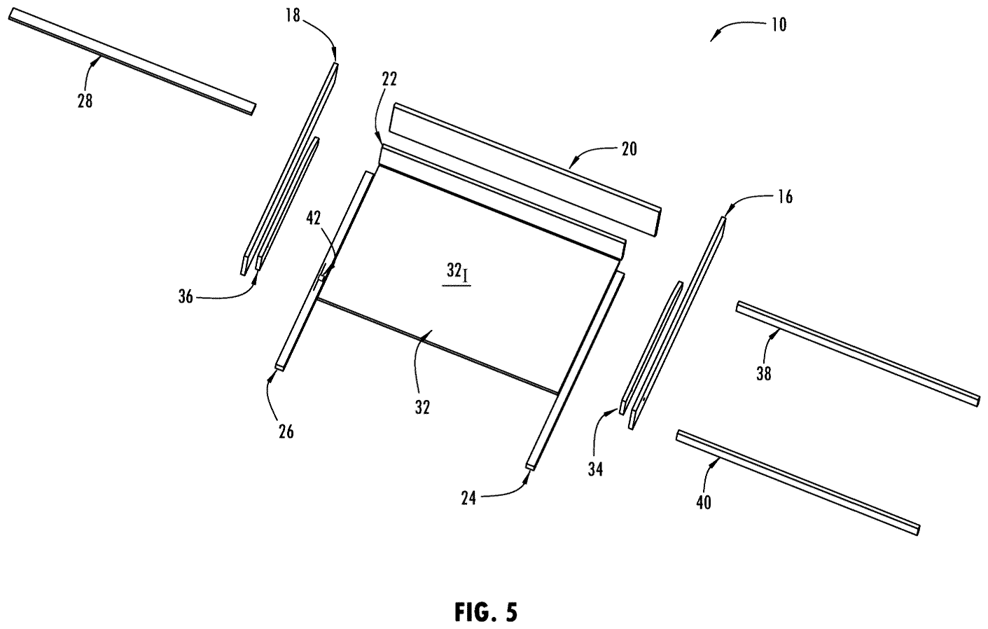

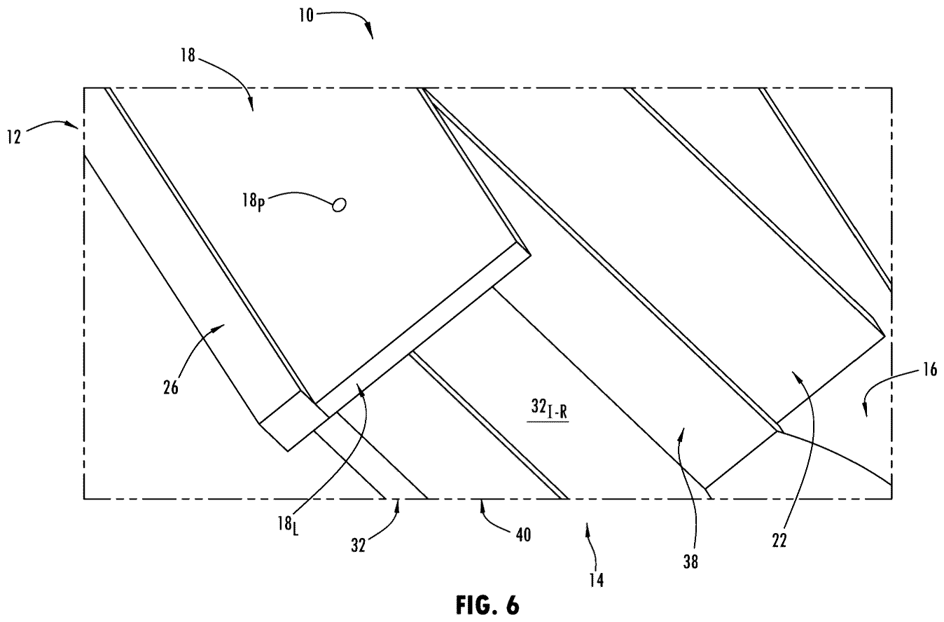

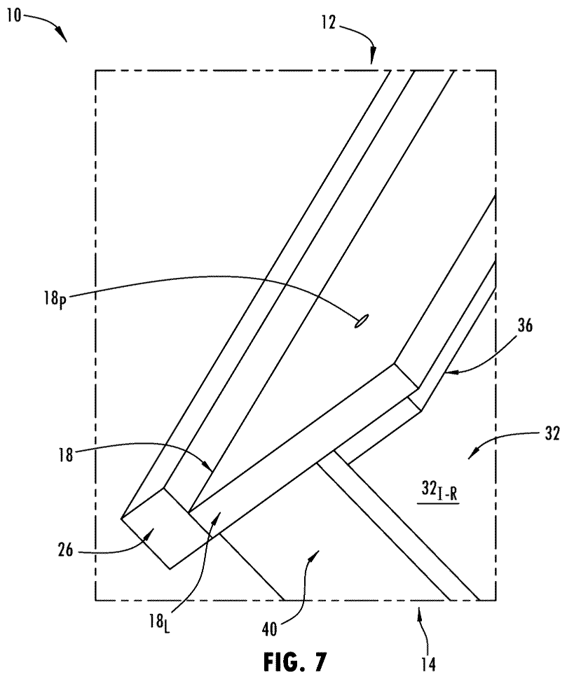

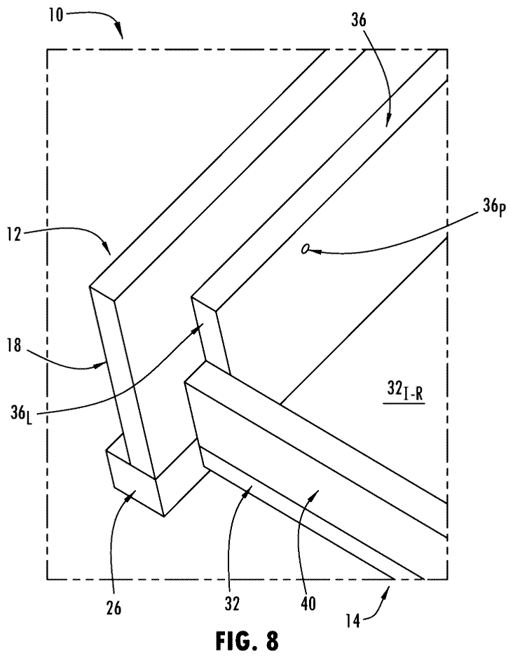

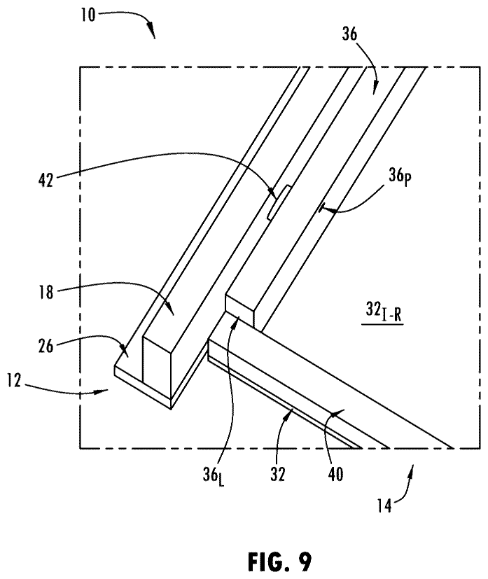

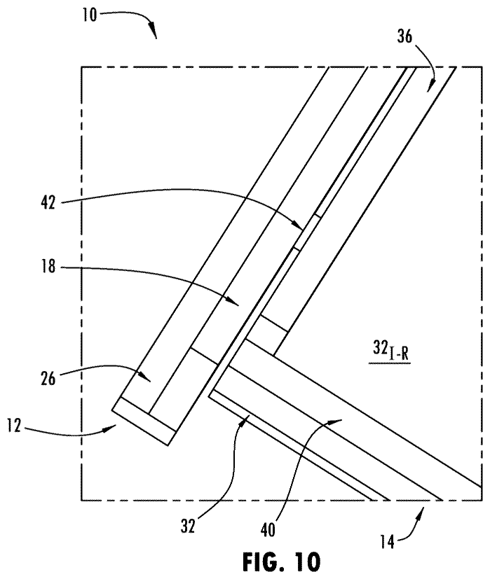

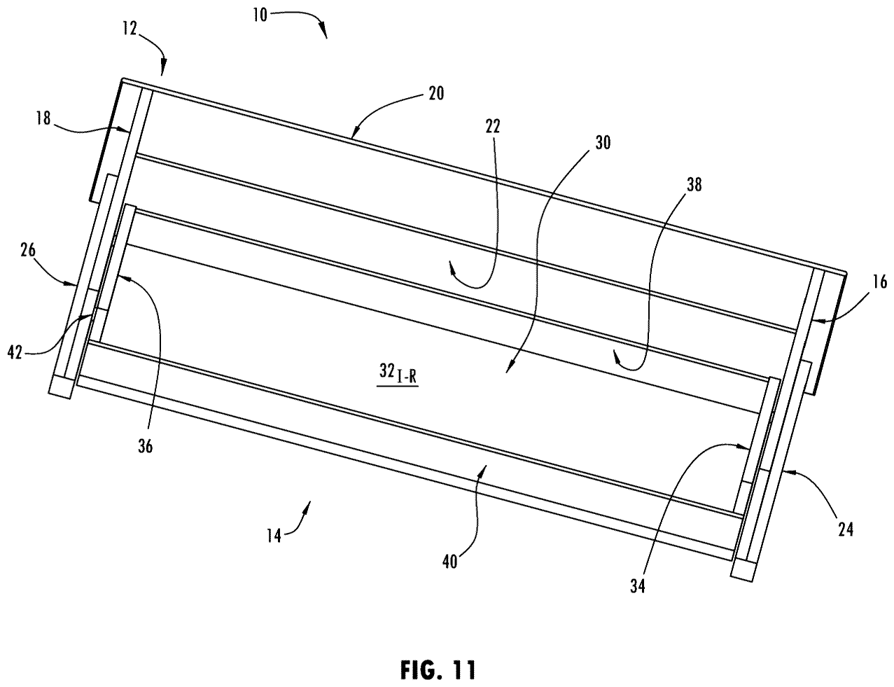

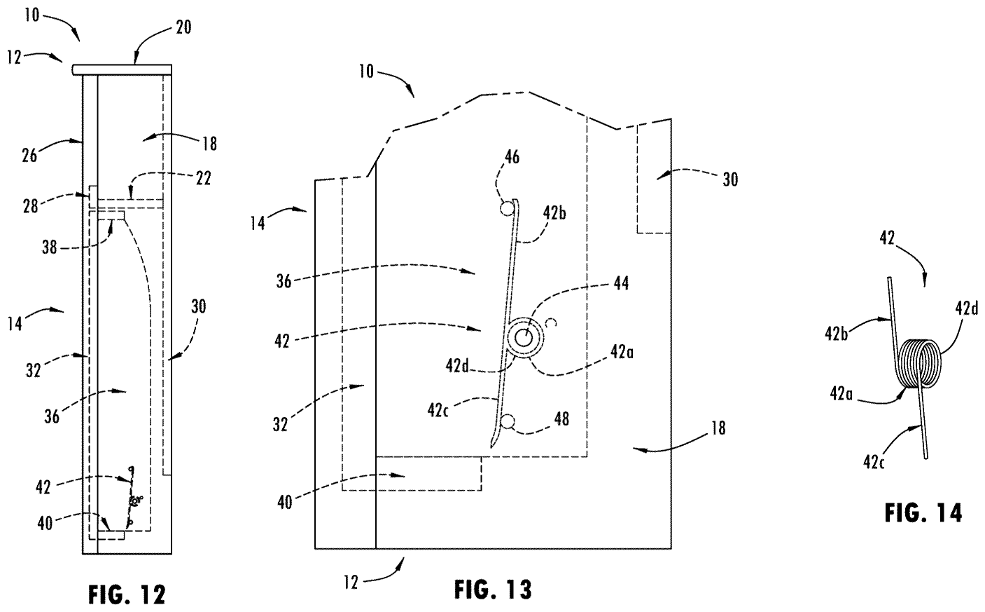

Referring also to FIGS. 1-14, an exemplary configuration of the support portion 14 of the container 10 is described. The support portion 14 includes a support panel 32, a first side panel 34 (see, e.g., FIGS. 2-5), a second side panel 36 (see, e.g., FIGS. 2-5), a first end panel 38 (see, e.g., FIGS. 2-5), and a second end panel 40 (see, e.g., FIGS. 2-5). The members and panels 32-40 that form the support portion 14 may be connected with one or more fasteners (e.g., dowels, nails, screws, washers), adhesive, or the like (not shown); in some examples, the one or more fasteners may include one or more cam lock nuts F₁ (see, e.g., FIG. 24) and one or more cam screws F₂ (see, e.g., FIG. 25) for joining a first panel P₁ (see, e.g., FIGS. 26-27) of the members and panels 32-40 that form the support portion 14 to a second panel P₂ (see, e.g., FIGS. 26-27) of the members and panels 32-40 that form the support portion 14. As such, the support portion 14 may be a ready-to-assemble (RTA) furniture component that may be assembled by a user rather than assembled by a furniture manufacturer.

If one or more cam nuts F₁ and one or more cam screws F₂ are utilized for assembling the support portion 14, the support portion 14 may be assembled as follows. For example, as seen at FIG. 26, a cam nut F₁ may be rotatably-disposed within a cam nut-receiving bore P_{B1} of a first member/panel P₁ of the members/panels 16-30 of the base portion 12, and a cam screw F₂ may be threadingly-secured within a threaded bore P_{B2} (see, e.g., FIG. 27) formed by a second member/panel P₂ of the members/panels 32-40 of the support portion 14. In order to connect the first member/panel P₁ (that includes the one or more cam nuts F₁) to the second member/panel P₂ (that includes the one or more cam screws F₂), the cam screw F₂ is axially-aligned with (see, e.g., FIG. 26) a cam nut bore access passageway bore P_{B3} (see, e.g., FIG. 26) that is formed by the first member/panel P₁ and then the cam screw F₂ is inserted into (see, e.g., FIG. 27) the cam nut bore access passageway bore P_{B3}. As seen at FIGS. 26-27, the cam nut bore access passageway bore P_{B3} is substantially perpendicular with respect to the cam nut-receiving bore P_{B1}. As seen at FIG. 27, once a distal end F_{2D} of the cam screw F₂ is interfaced with a proximal end F_{1P} of the cam nut F₁, a user utilizes a tool T (see, e.g., FIG. 27), such as, a screwdriver, in order to engage a distal end F_{1D} of the cam nut F₁ to rotate R the cam nut F₁. Rotation R of the cam nut F₁ results in the application of a pulling force or a drawing force X (that is orthogonal to a rotations axis A_{R}-A_{R} of the cam nut F₁) to the cam screw F₂. As a result, an outer surface P_{2S} of the second panel P₂ that includes the cam screw F₂ extending therefrom is drawn into close or tight engagement with an outer surface P_{1S} of the first panel P₁ that provides access to the cam nut bore access passageway bore P_{B3}.

Referring to FIG. 3, an exemplary connection arrangement of the members/panels 32-40 of the support portion 14 is now described. A lower surface 34_{L} of the first side panel 34 is secured to an inner surface 32_{I} (see, e.g., FIG. 5) of the support panel 32 near a first side surface 32_{S1} of the support panel 32. A lower surface 36_{L} of the second side panel 36 is secured to the inner surface 32_{I} of the support panel 32 near a second side surface 32_{S2} of the support panel 32 (that is opposite the first side surface 32_{S1} of the support panel 32).

A lower surface 38_{L} of the first end panel 38 is secured to the inner surface 32_{I} of the support panel 32 near a third side surface 32_{S3} of the support panel 32; the third side surface 32_{S3} of the support panel 32 is connected to a first end of the first side surface 32_{S1} of the support panel 32 and a first end of the second side surface 32_{S2} of the support panel 32. A lower surface 40_{L} of the second end panel 40 is secured to the inner surface 32_{I} of the support panel 32 near a fourth side surface 32_{S4} of the support panel 32 (that is opposite the third side surface 32_{S3} of the support panel 32); furthermore, the fourth side surface 32_{S4} of the support panel 32 is connected to a second end of the first side surface 32_{S1} of the support panel 32 and a second end of the second side surface 32_{S2} of the support panel 32.

With reference to FIGS. 3-5 and 9-13, the container 10 also includes at least one damper 42 (see, e.g., FIG. 14) that is connected to or supported by one or both of the base portion 12 and the support portion 14. In some instances, the at least one damper 42 may resist (but not prevent) movement of the support portion 14 from the stowed orientation (see, e.g., FIG. 1) to the deployed orientation (see, e.g., FIG. 2); and/or the at least one damper 42 may assist (but not provide sufficient force for) movement of the support portion 14 from the deployed orientation (see, e.g., FIG. 2) back to the stowed orientation (see, e.g., FIG. 1). The at least one damper 42 may be any structure or assembly that provides for resistance and/or assistance of movement, such as, for example, a combination of one or more of a spring, a cable, a pulley, and/or a weight.

As seen at FIGS. 13-15, in some configurations, the at least one damper 42 includes one or more torsion springs. The one or more torsion springs 42 includes a coiled body 42a (see, e.g., FIGS. 14-15), a first spring leg 42b (see, e.g., FIGS. 14-15), and a second spring leg 42c (see, e.g., FIGS. 14-15). When arranged in an at-rest state (as seen at FIGS. 13-15), the first spring leg 42b extends in a first direction, and the second spring leg 42c extends in a second direction that is opposite the first direction.

In order to connect the one or more torsion springs 42 to the container 10, one or more damper-supporting posts 44 (see, e.g., FIG. 14) extend from or is connected to one or more of the: (A) the inner side surface 16_{I} of the first leg member 16 of the base portion 12; (B) the inner side surface 18_{I} of the second leg member 18 of the base portion 12; (C) an outer side surface 34_{O} of the first side panel 34 of the support portion 14; and (D) an outer side surface 36_{O} of the second side panel 36 of the support portion 12. The one or more damper-supporting posts 44 extend through a passage 42d (see, e.g., FIGS. 14-15) extending through the coiled body 42a of the one or more torsion springs 42 for connecting the one or more torsion springs 42 to the container 10.

In some implementations, the container 10 includes: a first torsion spring 42 supported by a first damper-supporting post 44 extending from the inner side surface 16_{I} of the first leg member 16 of the base portion 12; and a second torsion spring 42 supported by a second damper-supporting post 44 extending from the inner side surface 18_{I} of the second leg member 18 of the base portion 12. In other implementations, the container 10 includes: a first torsion spring 42 supported by a first damper-supporting post 44 extending from the outer side surface 34_{O} of the first side panel 34 of the support portion 14; and a second torsion spring 42 supported by a second damper-supporting post 44 extending from the outer side surface 36_{O} of the second side panel 36 of the support portion 12. In further implementations, the container 10 includes: a first torsion spring 42 supported by a first damper-supporting post 44 extending from the inner side surface 16_{I} of the first leg member 16 of the base portion 12; and a second torsion spring 42 supported by a second damper-supporting post 44 extending from the outer side surface 34_{O} of the first side panel 34 of the support portion 14. In even further implementations, the container 10 includes: a first torsion spring 42 supported by a first damper-supporting post 44 extending from the inner side surface 18_{I} of the second leg member 18 of the base portion 12; and a second torsion spring 42 supported by a second damper-supporting post 44 extending from the outer side surface 36_{O} of the second side panel 36 of the support portion 12.

Furthermore, in order to resist (but not prevent) movement of the support portion 14 from the stowed orientation (see, e.g., FIG. 1) to the deployed orientation (see, e.g., FIG. 2), and/or assist (but not provide sufficient force for) movement of the support portion 14 from the deployed orientation (see, e.g., FIG. 2) back to the stowed orientation (see, e.g., FIG. 1), the one or more torsion springs 42 are disposed adjacent and impart a force to one or more first spring-leg-engaging pegs 46 (see, e.g., FIG. 14) and one or more second spring-leg-engaging pegs 48 (see, e.g., FIG. 14). In some implementations, the one or more first spring-leg-engaging pegs 46 and/or one or more second spring-leg-engaging pegs 48 integrally extend from or is connected to one or more of: (A) the inner side surface 16_{I} of the first leg member 16 of the base portion 12; (B) the inner side surface 18_{I} of the second leg member 18 of the base portion 12; (C) the outer side surface 34_{O} of the first side panel 34 of the support portion 14; and (D) the outer side surface 36_{O} of the second side panel 36 of the support portion 12. In some arrangements, the one or more first spring-leg-engaging pegs 46 is disposed adjacent the first spring leg 42b of the one or more torsion springs 42. In other arrangements, the one or more second spring-leg-engaging pegs 48 is disposed adjacent the second spring leg 42c of the one or more torsion springs 42. Accordingly, the one or more torsion springs 42 (defined by the coiled body 42a, the first spring leg 42b, and the second spring leg 42c) may apply a force (i.e., a torque) to one or both of the one or more first spring-leg-engaging pegs 46 and the one or more second spring-leg-engaging pegs 48 in the course of moving the support portion 14 relative the base portion 12 to/from the stowed orientation (see, e.g., FIG. 1) and the deployed orientation (see, e.g., FIG. 2).

In some implementations, when the support portion 14 is arranged in the stowed orientation relative the base portion 12, the one or more torsion springs 42 may provide a stowed orientation torque approximately equivalent to ten (10) inch-pounds/0.83 foot-pounds/1.13 Newton-Meters. In other implementations, when the support portion 14 is arranged in a 90°-full-open/deployed orientation relative the base portion 12, the one or more torsion springs 42 may provide a deployed orientation torque approximately equivalent to eighty-five (85) inch-pounds/7.08 foot-pounds/8.85 Newton-Meters.

In other implementations, when the support portion 14 is arranged in the stowed orientation relative the base portion 12, the one or more torsion springs 42 may provide a stowed orientation torque approximately equivalent to twenty (20) inch-pounds/1.66 foot-pounds/2.25 Newton-Meters. In other implementations, when the support portion 14 is arranged in a 90°-full-open/deployed orientation relative the base portion 12, the one or more torsion springs 42 may provide a deployed orientation torque approximately equivalent to one-hundred-and-seventy (170) inch-pounds/14.2 foot-pounds/19.25 Newton-Meters.

In some examples, the stowed orientation torque ranges between approximately ten-to-twenty (10-to-20) inch-pounds/0.83-to-1.66 foot-pounds/1.13-to-2.25 Newton-Meters. In other examples, the deployed orientation torque ranges between approximately eighty-five-to-one-hundred-and-seventy (85-to-170) inch-pounds/7.08-to-14.2 foot-pounds/8.85-to-19.25 Newton-Meters.

With reference to FIGS. 1-2, the container 10 also includes a first pivot pin 50 (see, e.g., FIG. 2) and a second pivot pin 52 (see, e.g., FIGS. 1-2). The first pivot pin 50 and the second pivot pin 52 rotatably-connect the support portion 14 to the base portion 12 in order to permit the support portion 14 to be arranged in one of the stowed orientation (see, e.g., FIG. 1) and the deployed orientation (see, e.g., FIG. 2) relative the base portion 12.

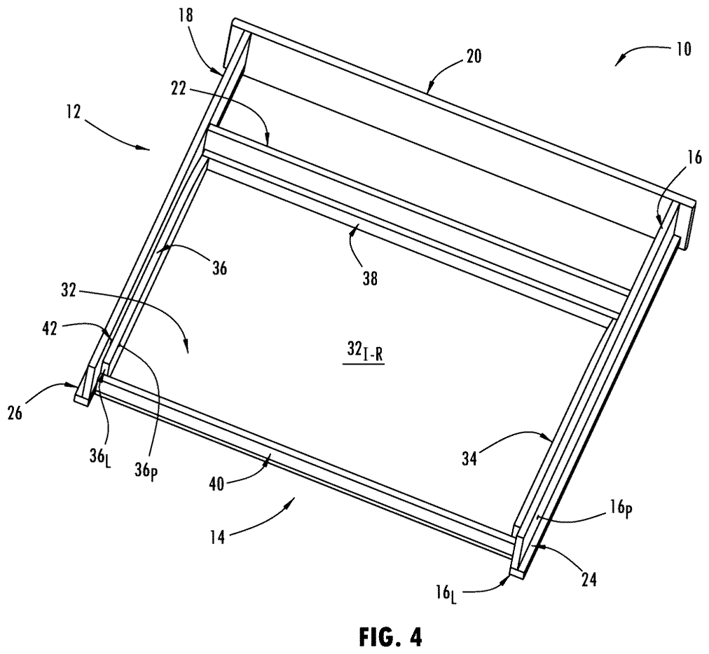

As seen at FIGS. 2 and 3-4, the first pivot pin 50 extends through and is arranged within: (1) a pivot pin passage 16_{P} (see, e.g., FIG. 4) formed near a lower end 16_{L} of the first leg member 16 of the base portion 12; and (2) a pivot pin passage 34_{P} (see, e.g., FIGS. 2-3) formed near a lower end 34_{L} of the first side panel 34 of the support portion 14. As seen at FIGS. 1-2, the second pivot pin 52 extends through and is arranged within: (1) a pivot pin passage 18_{P} (see, e.g., FIGS. 1-3 and 6-7) formed near a lower end 18_{L} of the second leg member 18 of the base portion 12; and (2) a pivot pin passage 36_{P} (see, e.g., FIGS. 4 and 8-9) formed near a lower end 36_{L} of the second side panel 36 of the support portion 14.

Referring back to FIG. 2, after the first side panel 34, the second side panel 36, the first end panel 38, and the second end panel 40 are secured to the inner surface 32_{I} of the support panel 32 for forming the support portion 14, the panels 34, 36, 38, 40 may collectively define an item retaining barrier 54. Furthermore, after the first side panel 34, the second side panel 36, the first end panel 38, and the second end panel 40 are secured to the inner surface 32_{I} (see, e.g., FIG. 5) of the support panel 32 for forming the support portion 14, a remainder 32_{I-R} of a surface area (see, e.g., FIGS. 2, 4, and 6-11) defined by the inner surface 32_{I} of the support panel 32 (i.e., the surface area where the panels 34, 36, 38, 40 are not secured to the support panel 32) provides a support surface for one or more of the items 1, 2, 3.

With further reference to FIG. 2, in some configurations, the first leg member 16, the second leg member 18, and the shelf panel 22 may collectively form a support portion-receiving cavity 56 having a width dimension W₅₆ and a height dimension H₅₆. The width dimension W₅₆ extends between opposing inner surfaces 16_{I}, 18_{I} of the first leg member 16 and the second leg member 18. The height dimension H₅₆ extends between a lower side surface 22_{SL} of the shelf panel 22 and a lower surface 16_{L}, 18_{SL} of each of the first leg member 16 and the second leg member 18.

Additionally, the first leg member 16 and the second leg member 18 respectively include a width dimension W₁₆ (see, e.g., FIG. 3), W₁₈ (see, e.g., FIG. 3) extending between the respective front surfaces 16_{F}, 18_{F} and the respective rear surfaces 16_{R}, 18_{R} of each of the first leg member 16 and the second leg member 18. In some implementations, the width dimension W₁₆, W₁₈ of the first leg member 16 and the second leg member 18 are the same. In some instances, the width dimension W₁₆, W₁₈ of the first leg member 16 and the second leg member 18 is approximately equal to (e.g., slightly greater than or slightly less than) the height dimension H₅₄ of the item retaining barrier 54 of the support portion 14. Accordingly, when the support portion 14 is arranged in the stowed orientation relative the base portion 12 (as seen in, e.g., FIG. 1), the support portion 14 may be said to nested within the support portion-receiving cavity 56 of the base portion 12 such that an outer surface 32_{O} (see, e.g., FIG. 1) of the support panel 32 of the support portion 14 may be substantially aligned with at least one of the: (1) front surfaces 16_{F}, 18_{F} of the first leg member 16 and the second leg member 18; and (2) front surfaces 24_{F}, 26_{F} of the optional first leg member trim panel 24 and the optional second leg member trim panel 26.

Referring to FIGS. 15, an exemplary assembly 100 is shown. The assembly 100 includes the container 10 and one item 1 (e.g., a pillow). The exemplary pillow 1 seen at FIG. 15 includes a cuboidal shape body defined by a length L₁, width W₁, and a thickness T₁. In some configurations, the width W₁ is greater than the length L₁, and, as such, the pillow 1 may define a rectangular-cuboidal-shaped body.

As seen at FIG. 15, the width W₁ of the pillow 1 extends between a first lateral side surface of the pillow 1 and a second lateral side surface of the pillow 1. The length L₁ of the pillow 1 extends between a front side surface of the pillow 1 and a rear side surface of the pillow 1. The thickness T₁ of the pillow 1 extends between a top surface of the pillow 1 and a bottom surface of the pillow 1.

With reference to FIG. 15, the support portion 14 is configured for interfacing with the exemplary pillow 1. For example, the height dimension H₅₄ (see, e.g., FIG. 2) of the item retaining barrier 54 of the support portion 14 may be approximately equal to (or, e.g., slightly greater than) the thickness T₁ of the pillow 1. In another example, the remainder 32_{I-R} of the surface defined by the inner surface 32_{I} of the support panel 32 may be approximately equal to (or, e.g., slightly greater than) the surface area of the bottom surface of the pillow 1 as defined by the length L₁ and the width W₁ of the pillow 1.

As a result of the relative dimensions of the item retaining barrier 54 of the support portion 14 and the thickness T₁ of the pillow 1, lateral movement of the pillow 1 away from the inner surface 32_{I} of the support panel 32 is prevented when, for example, the support portion 14 is arranged in any of: the partially deployed orientation (not shown); and the deployed orientation (see, e.g., FIGS. 2 and 15). Furthermore, when the support portion 14 is arranged in any of: the stowed orientation (see, e.g., FIG. 1); the partially deployed orientation (not shown); and the deployed orientation (see, e.g., FIGS. 2 and 15), the support portion 14 is sized for receivably-supporting and containing the pillow 1 such that pillow 1 may remain arranged upon the inner surface 32_{I} of the support panel 32 during any orientation of the support portion 14 relative the base portion 12.

Referring to FIG. 17, an exemplary assembly 200 is shown. The assembly 200 includes the container 10 and two items 2, 3 (e.g., a pan and a housing/knock-down kennel/a knock-down cage). When the housing 3 is arranged in the expanded orientation (see also, e.g., FIG. 17), the housing 3 includes a cuboidal shape body defined by a length L₃, width W₃, and a height H₃. In some configurations, the width W₃ is greater than the length L₃, and, as such, the housing 3 may define a rectangular-cuboidal-shaped body.

Furthermore, because the housing 3 is configurable between a collapsed orientation and an expanded orientation, the height H₃ may be alternatively referred to as an “expanded orientation height”. Therefore, when the housing 3 is arranged in the collapsed orientation (not shown), the housing 3 may be alternatively defined by a “collapsed orientation height” that is seen at, for example, reference numeral H₃′. The collapsed orientation height H₃′ is generally defined by a stacked arrangement of all of the panels 3_{F}, 3_{T}, 3_{R}, 3_{S1}, 3_{S2}, 3_{B} of the housing 3, which may include, for example: a front side panel 3_{F}, a top side panel 3_{T}, a rear side panel 3_{R}, a first lateral side panel 3_{S1}, a second lateral side panel 3_{S2}, and a bottom side panel 3_{B}. Accordingly, the collapsed orientation height H₃′ may be generally equal to a collective thickness defined by a thickness of each of the front side panel 3_{F}, the top side panel 3_{T}, the rear side panel 3_{R}, the first lateral side panel 3_{S1}, the second lateral side panel 3_{S2}, and the bottom side panel 3_{B}.

As seen at, for example, FIG. 16B, the width W₃ of the housing 3 extends between the first lateral side panel 3_{S1} of the housing 3 and the second lateral side panel 3_{S2} of the housing 3.

The length L₃ of the housing 3 extends between the front side panel 3_{F} of the housing 3 and the rear side panel 3_{R} of the housing 3. The height H₃ of the housing 3 extends between the top side panel 3_{T} of the housing 3 and the bottom side panel 3_{B} of the housing 3.

With reference to FIG. 17, the support portion 14 is configured for interfacing with the exemplary housing 3 that also includes or contains the pan 2 (as seen at, for example, FIGS. 16A-16B). In some configurations, the remainder 32_{I-R} of the surface area defined by the inner surface 32 of the support panel 32 may be approximately equal to (or, e.g., slightly greater than) the surface area of the bottom side panel 3_{B} of the housing 3 as defined by the length L₃ and the width W₃ of the housing 3.

In some instances, when the housing 3 is arranged in the collapsed or substantially flat orientation (not shown), the collapsed orientation height H₃′ of the housing 3 may be equal to or less than the height dimension H₅₄ (see, e.g., FIG. 2) of the item retaining barrier 54 of the support portion 14. Accordingly, the relative dimensions of the item retaining barrier 54 of the support portion 14 and the collapsed orientation height H₃′ of the housing 3 prevents lateral movement of the (collapsed orientation of the) housing 3 away from the inner surface 32_{I} of the support panel 32. In another example, when the housing 3 is arranged in the expanded orientation as seen at, for example, FIG. 16B, the height H₃ of the housing 3 is greater (when the housing 3 is arranged in the expanded orientation) than the height dimension H₅₄ (see, e.g., FIG. 2) of the item retaining barrier 54 of the support portion 14, the relative dimensions of the item retaining barrier 54 of the support portion 14 and the height H₃ of the housing 3 prevents lateral movement of the housing 3 away from the inner surface 32_{I} of the support panel 32.

Furthermore, as a result of the relative dimensions of the item retaining barrier 54 of the support portion 14 and the location of the shelf panel 22 of the base portion 12, the container 10 may prevent movement of the housing 3 when the housing 3 is arranged in the expanded orientation. For example, the expanded orientation height H₃ of the housing 3 may be approximately the same as but less than the height dimension H₅₆ (see, e.g., FIG. 2) of the support portion-receiving cavity 56. Accordingly, once the housing 3 is arranged in the expanded orientation (while being already supported upon the remainder 32_{I-R} of the surface area defined by the inner surface 32_{I} of the support panel 32), a portion (see, e.g., reference numeral 3_{T-P} at FIG. 16B) of the top panel 3_{T} of the housing 3 (that is near the rear side panel 3_{R} of the housing 3 and extends across the width W₃ of the housing 3) may be arranged adjacent, opposite, or proximate the lower side surface 22_{SL} of the shelf panel 22. By arranging the portion 3_{T-P} of the top panel 3_{T} of the housing 3 adjacent, opposite, or proximate the lower side surface 22_{SL} of the shelf panel 22, the expanded orientation of the housing 3 is prevented from pivoting, as seen at FIG. 17: (1) forwardly according to the direction of pivot arrow P_{3F}; (2) laterally sideways in a first sideways direction according to the direction of pivot arrow P_{3S1}; or (3) laterally sideways in a second sideways direction according to the direction of pivot arrow P_{3S2}.

A method for operating the assembly 200 is now described. Firstly, the support portion 14 of the container 10 is arranged in a stowed orientation relative the base portion 12 of the container 10. Although not shown, the pan 2 and the housing 3 are stored within the container 10 whereby the housing 3, which includes the pan 2, is arranged in the collapsed orientation. When the container 10 and the housing 3 and the pan 2 (both of which are not shown due to being contained within the container 10), the floor space in front of the container 10 is not obstructed, and, furthermore, the pan 2 and housing 3 are not visible thereby providing a roomier, “cleaner” appearance for the room or environment where the container 10, pan 2, and housing 3 are located.

Although no ancillary items are shown arranged upon an upper side surface 22_{SU} of the shelf panel 22, any desirable item may be arranged upon the upper side surface 22_{SU} of the shelf panel 22. In some instances, exemplary items that may be arranged upon the upper side surface 22_{SU} of the shelf panel 22 may include, for example, a pet leash, pet toys, or the like.

Once the support portion 14 is arranged in a deployed orientation relative the base portion 12, the pan 2 and housing 3 are now accessible and no longer “hidden” from view by the container 10. Moreover, the housing 3 is shown in a collapsed orientation whereby the plurality of panels 3_{F}, 3_{T}, 3_{R}, 3_{S1}, 3_{S2}, 3_{B} defining the housing 3 are arranged in a stacked orientation that defines the collapsed orientation height H₃′ of the housing 3. In some configurations, an upper-most panel of the plurality of panels 3_{F}, 3_{T}, 3_{R}, 3_{S1}, 3_{S2}, 3_{B} defining the housing 3 is the front side panel 3_{F} of the housing 3.

A user may grasp the front side panel 3_{F} of the housing 3 and pivot the front side panel 3_{F} of the housing 3 away from the inner surface 32_{I} of the support panel 32 of the support portion 14. Because the plurality of panels 3_{F}, 3_{T}, 3_{R}, 3_{S1}, 3_{S2}, 3_{B} defining the housing 3 may be linked to one another, when the front side panel 3_{F} of the housing 3 is pivoted away from the inner surface 32_{I} of the support panel 32 of the support portion 14, access to the “next available panel” in the stack of panels 3_{F}, 3_{T}, 3_{R}, 3_{S1}, 3_{S2}, 3_{B} defining the housing 3 is provided.

In some examples, the “next available panel” may be the top panel 3_{T} of the housing 3. Furthermore, another stacked panel of the stack of panels 3_{F}, 3_{T}, 3_{R}, 3_{S1}, 3_{S2}, 3_{B} defining the housing 3 is also revealed; this panel may be, for example, the rear side panel 3_{R} of the housing 3. The user may then grasp the top panel 3_{T} of the housing 3 and pull the top panel 3_{T} of the housing 3 away from the inner surface 32_{I} of the support panel 32 of the support portion 14.

When the user grasps and pulls the top panel 3_{T} of the housing 3 away from the inner surface 32_{I} of the support panel 32 of the support portion 14 (and because the plurality of panels 3_{F}, 3_{T}, 3_{R}, 3_{S1}, 3_{S2}, 3_{B} defining the housing 3 may be linked to one another), the front side panel 3_{F} of the housing 3 and the rear side panel 3_{R} of the housing 3 may pivoted for arrangement in nearly but not yet a perpendicular orientation with respect to the inner surface 32_{I} of the support panel 32 of the support portion 14. Movement imparted to the top panel 3_{T} of the housing 3 away from the inner surface 32_{I} of the support panel 32 of the support portion 14 may cease when the front side panel 3_{F} of the housing 3 and the rear side panel 3_{R} of the housing 3 are pivoted for arrangement in a perpendicular orientation with respect to the inner surface 32_{I} of the support panel 32 of the support portion 14.

The user may then grasp the first lateral side panel 3_{S1} of the housing 3 and pivot the first lateral side panel 3_{S1} of the housing 3 away from the inner surface 32_{I} of the support panel 32 of the support portion 14. A lower end of the first lateral side panel 3_{S1} of the housing 3 is pivotably connected to a first end of the bottom side panel 3_{B} of the housing 3. Pivoting of the first lateral side panel 3_{S1} of the housing 3 may cease once the first lateral side panel 3_{S1} of the housing 3 is arranged in a perpendicular orientation with respect to the inner surface 32_{I} of the support panel 32 of the support portion 14. Once the first lateral side panel 3_{S1} of the housing 3 is arranged in the perpendicular orientation with respect to the inner surface 32_{I} of the support panel 32 of the support portion 14, the user may secure or snap into place a first end of the top side panel 3_{T} of the housing 3.

The user may then grasp the second lateral side panel 3_{S2} of the housing 3 and pivot the second lateral side panel 3_{S2} of the housing 3 away from the inner surface 32_{I} of the support panel 32 of the support portion 14. A lower end of the second lateral side panel 3_{S2} of the housing 3 is pivotably connected to a second end of the bottom side panel 3_{B} of the housing 3. Pivoting of the second lateral side panel 3_{S2} of the housing 3 may cease once the second lateral side panel 3_{S2} of the housing 3 is arranged in a perpendicular orientation with respect to the inner surface 32_{I} of the support panel 32 of the support portion 14. Once the second lateral side panel 3_{S2} of the housing 3 is arranged in the perpendicular orientation with respect to the inner surface 32_{I} of the support panel 32 of the support portion 14, the user may secure or snap into place a second end of the top side panel 3_{T} of the housing 3.

Once the second lateral side panel 3_{S2} of the housing 3 is connected to the top side panel 3_{T} of the housing 3, the housing 3 may be said to be arranged in the expanded orientation. As described above, once the housing 3 is arranged in the expanded orientation (while being already supported upon the remainder 32_{I-R} of the surface area defined by the inner surface 32_{I} of the support panel 32), the portion 3_{T-P} of the top panel 3_{T} of the housing 3 that is near the rear side panel 3_{R} of the housing 3 and extends across the width W₃ of the housing 3 may be arranged adjacent, opposite, or proximate the lower side surface 22_{SL} of the shelf panel 22.

Furthermore, a rear surface 38_{R} of the first end panel 38 of the support portion 14 (that is defined by the height dimension H₅₄ of the item retaining barrier 54 of the support portion 14) may extend along and be arranged opposite a portion of the front side panel 3_{F} of the housing 3 whereby the first end panel 38 prevent forwardly movement of the housing 3 orthogonally away from the optional rear trim panel 30 of the base portion 12 according to the direction of arrow D1 (see, e.g., FIG. 17). Therefore, the first end panel 38 may assist in retaining the housing 3 upon or over the inner surface 32_{I} of the support panel 32 of the support portion 14. Even further, one or both of the first leg member 16 of the base portion 12 and the first side panel 34 of the support portion 14 prevent first sideways movement of the housing 3 orthogonally away from the one or both of the first leg member 16 of the base portion 12 and the first side panel 34 of the support portion 14 according to the direction of arrow D2 (see, e.g., FIG. 17). Yet even further, one or both of the second leg member 18 of the base portion 12 and the second side panel 36 of the support portion 14 prevent second sideways movement of the housing 3 orthogonally away from the one or both of the second leg member 18 of the base portion 12 and the second side panel 36 of the support portion 14 according to the direction of arrow D3 (see, e.g., FIG. 17). Also, by arranging the portion 3_{T-P} of the top panel 3_{T} of the housing 3 adjacent, opposite, or proximate the lower side surface 22_{SL} of the shelf panel 22, the expanded orientation of the housing 3 is prevented from pivoting: (1) forwardly according to the direction of pivot arrow P_{3F}; (2) laterally sideways in a first sideways direction according to the direction of pivot arrow P_{3S1}; or (3) laterally sideways in a second sideways direction according to the direction of pivot arrow P_{3S2}. Therefore, the container 10 not only may contain the pan 2 and the housing 3 when arranged in a collapsed orientation in order to provide a “cleaner” appearance for the room or environment where the container 10, pan 2, and housing 3 are located, the container 10 also reduces or eliminates separation or movement of the housing 3 relative the container once the housing 3 is arranged in an expanded orientation.

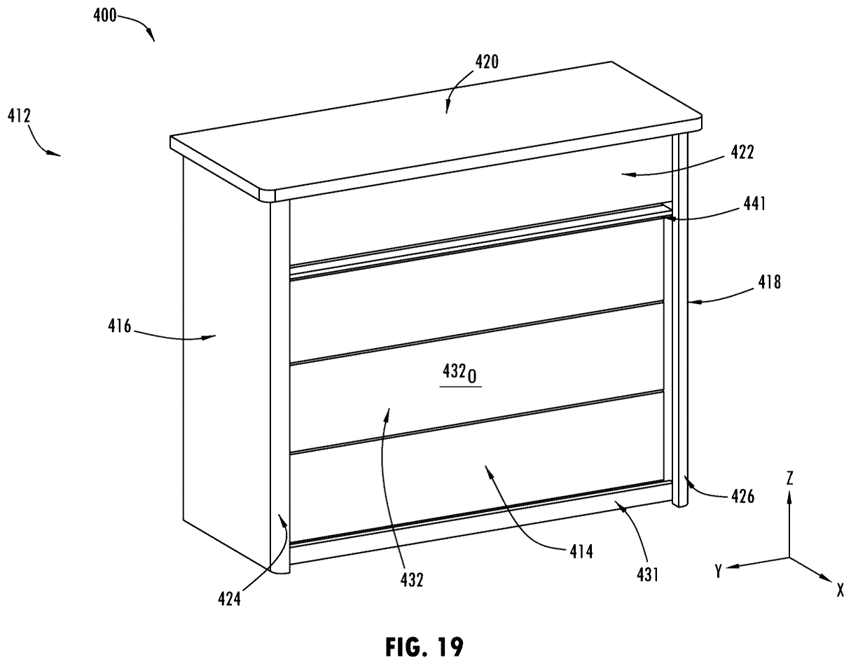

Referring to FIG. 19, an exemplary assembly 300 is shown. The assembly 300 includes the container 10 and three items 1, 2, 3 (e.g., a pillow, a pan, and a housing/knock-down kennel/a knock-down cage). The assembly 300 is substantially similar to the assembly 200 described above, and, therefore, the description at FIG. 17 is inclusive to the description associated with FIG. 19, and, therefore, is not repeated here for purposes of brevity. The difference between the assembly 200 and the assembly 300 is that the assembly 300 also includes the pillow 1.

After the assembly 200 has been formed as described above, the user may access a door 3_{D} of the housing 3 that is initially arranged in a closed orientation. The door 3_{D} of the housing 3 may be formed with or carried by the first lateral side panel 3_{S1} of the housing 3. The door 3_{D} of the housing 3 may permit or deny access to an opening 3_{O} formed by first lateral side panel 3_{S1} of the housing 3. The opening 3_{O} formed by first lateral side panel 3_{S1} of the housing 3 permits access to a cavity 3_{C} of the housing 3.

The user may then apply a pulling force to the door 3_{D} of the housing 3 for arranging the door 3_{D} of the housing 3 in an open orientation. Once the door 3_{D} of the housing 3 is arranged in the open orientation, the user may insert the pillow 1 through the opening 3_{O} formed by first lateral side panel 3_{S1} of the housing 3 such that the pillow 1 may be at least partially arranged within the cavity 3_{C} of the housing 3.

Thereafter, the user may fully place the pillow 1 within the cavity 3_{C} of the housing 3 such that the bottom surface (not shown) of the pillow 1 is arranged over or upon the bottom side panel 3_{B} of the housing 3. The bottom side panel 3_{B} of the housing 3 may be defined by the length L₃ and the width W₃ of the housing 3. The bottom surface of the pillow 1 may be defined by the length L₁ and the width W₁ of the pillow 1; in some configurations the length L₁ and the width W₁ of the pillow 1 may be approximately equal to but slightly less than the length L₃ and the width W₃ of the housing 3 as defined by the bottom side panel 3_{B} of the housing 3.

Once the pillow 1 is arranged upon or over the side panel 3_{B} of the housing 3, the user may then apply a pushing force to the door 3_{D} of the housing 3 for arranging the door 3_{D} of the housing 3 back to the closed orientation. Once the door 3_{D} of the housing 3 is arranged in the closed orientation, the assembly 300 may be said to be formed as a result of disposing the pillow 1 within the cavity 3_{C} of the housing 3.

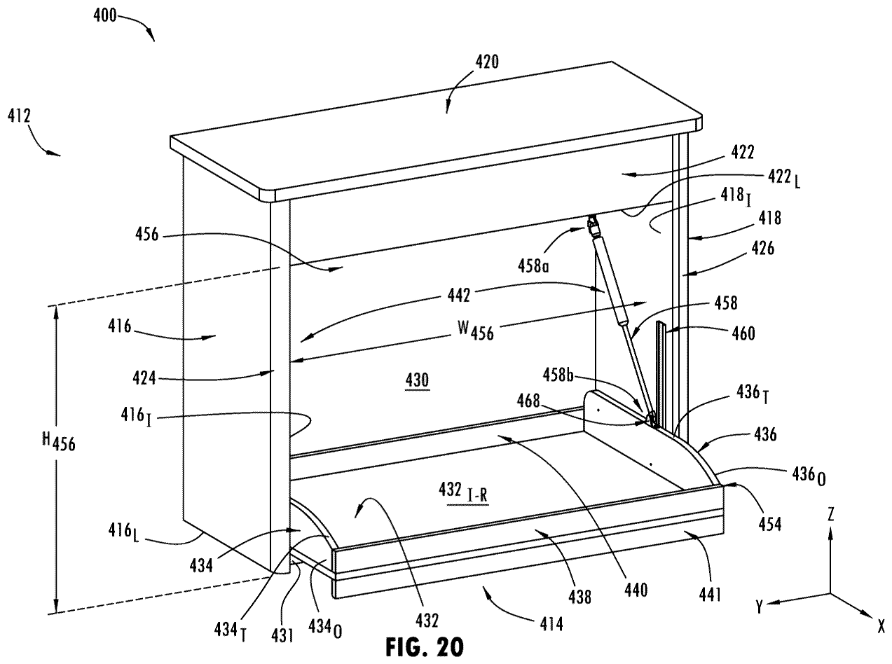

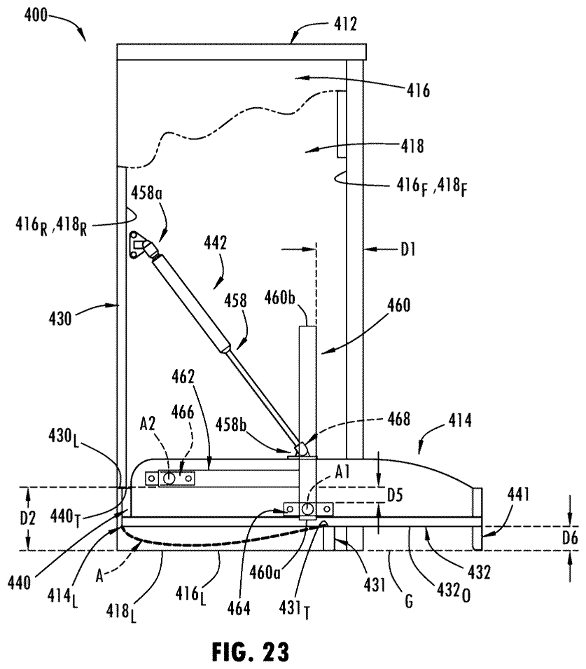

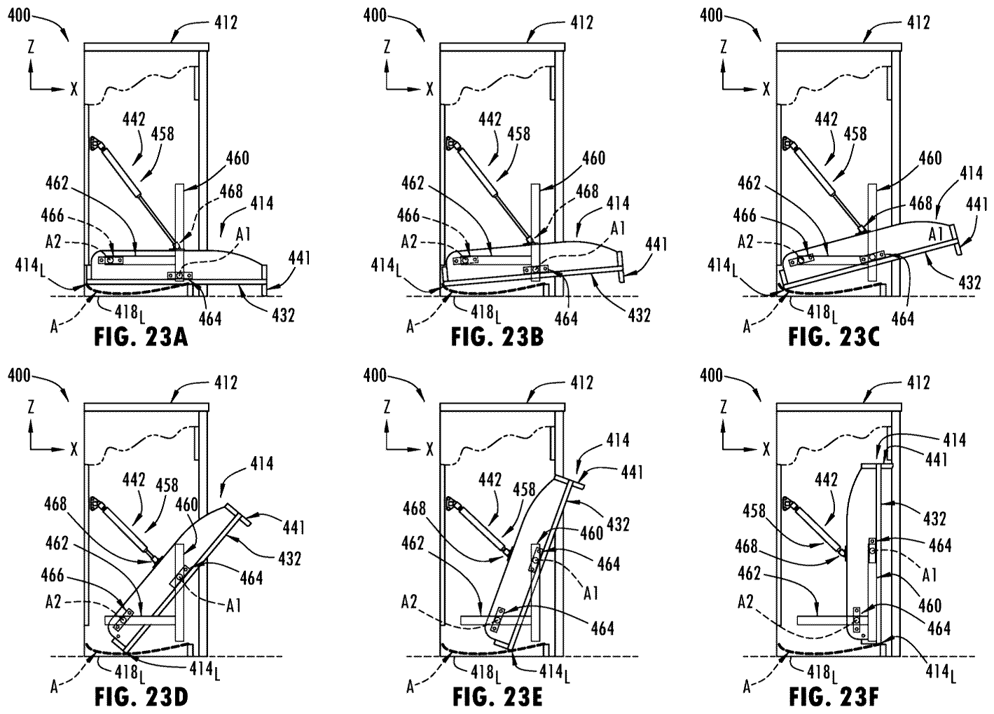

Further implementations of the present disclosure relate generally to a container 400 (see, e.g., FIGS. 19-20). The container 400 includes a base portion 412 and a support portion 414. The support portion 414 is arrangable relative the base portion 412 in: (1) a stowed orientation (see, e.g., FIGS. 19 and 23F); an intermediate orientation (see, e.g., FIGS. 23B-23E); or a deployed orientation (see, e.g., FIGS. 20, 23, and 23A). The support portion 414 is sized for supporting one item 1 (see, e.g., FIG. 15) or a plurality of items 2, 3 (see, e.g., FIGS. 16A-18). Furthermore, the one or more items 1 (see, e.g., FIGS. 15 and 18), 2 (see, e.g., FIGS. 17 and 18), 3 (see, e.g., FIGS. 17 and 18) may be contained within the container 400 when the support portion 414 of the container 400 is arranged in a stowed orientation relative the base portion 412 of the container 400. Furthermore, the container 400 may be substituted for the container 10 at, for example, FIGS. 15, 17, and 18, in order to form, respectively, the assembly 100 (see, e.g., FIG. 15), 200 (see, e.g., FIG. 17), 300 (see, e.g., FIG. 18) when the one or more items 1, 2, 3 is/are supported by the support portion 414 of the container 400.

The assemblies 100, 200, 300 provide a plurality of functions or intended uses. In some implementations, each assembly 100, 200, 300 may be sized for providing a rest area or housing for animalia (not shown, e.g., a dog, a cat).

In a first example, as seen at FIG. 15, the item 1 of the assembly 100 may include a pillow that is sized for arrangement upon the support portion 414 of the container 400. The pillow 1 may provide a rest area whereby the animalia (not shown) is free to rest upon or leave the assembly 100 at its convenience. Furthermore, in some configurations, the pillow 1 may be contained within the container 400 when the support portion 414 is arranged in a stowed orientation relative the base portion 412.

With reference to FIGS. 16A-16B, the items 2, 3 associated with the assembly 200 or the assembly 300 may respectively include a pan and a housing. The housing 3 may be in the form of, for example, a knock-down kennel/a knock-down cage, or the like. The housing/knock-down kennel/a knock-down cage 3 may include a plurality of panels 3_{F}, 3_{T}, 3_{R}, 3_{S1}, 3_{S2}, 3_{B} that may be arranged in: (1) a collapsed or substantially flat orientation (not shown); (2) a partially deployed or non-flat orientation (not shown); or (3) an expanded orientation (see, e.g., FIGS. 16A-16B, 17, 18).

In another example, as seen at FIG. 17, items 2, 3 are sized for arrangement upon the support portion 414 of the container 400. The plurality of panels 3_{F}, 3_{T}, 3_{R}, 3_{S1}, 3_{S2}, 3_{B} of the housing/knock-down kennel/a knock-down cage define a cavity 3_{C} (see, e.g., FIG. 16A). Access to the cavity 3_{C} is permitted by one or more openings 3_{O} (see, e.g., FIG. 16A) formed by the one or more panels 3_{F}, 3_{T}, 3_{R}, 3_{S1}, 3_{S2}. A door 3_{D} (see, e.g., FIG. 16A) is attached to one or more of the panels 3_{F}, 3_{T}, 3_{R}, 3_{S1}, 3_{S2} and is arrangable in one of a closed orientation (see, e.g., FIG. 16B) and an open orientation (see, e.g., FIG. 16A) in order to respectively deny access to or permit access to the one or more openings 3_{O}. The cavity 3_{C} of the housing 3 may provide a rest area whereby the animalia (not shown) may optionally not be free to leave the assembly 200 at its convenience depending on the closed orientation of the door 3_{D} or the open orientation of the door 3_{D}. When the door 3_{D} is in the open orientation, the animalia may enter or exit the cavity 3_{C} of the housing 3 by way of the one or more openings 3_{O}. When the door 3_{D} is in the closed orientation, the animalia may not enter or exit the cavity 3_{C} of the housing 3 by way of the one or more openings 3_{O}. The pan 2 may be selectively interfaced with a panel 3_{B} of the housing 3 (see, e.g., FIGS. 16A-16B) prior to arrangement of the housing 3 upon the support portion 414 of the container 400. The pan 2 may contain or capture, for example: food, water, urine, feces, vomit, or other bodily fluids. Furthermore, in some configurations, the pan 2 and the housing 3 may be contained within the container 400 when the support portion 414 is arranged in a stowed orientation relative the base portion 412; however, prior to arranging the support portion 414 in the stowed orientation relative the base portion 412, the housing 3 should be arranged in a collapsed orientation (not shown).

In yet another example, as seen at FIG. 18, the items 1, 2, 3 of the assembly 300 may respectively include a pillow, a pan, and a housing (e.g., a kennel or cage) that is sized for arrangement upon the support portion 414 of the container 400. The housing 3 includes a plurality of panels 3_{F}, 3_{T}, 3_{R}, 3_{S1}, 3_{S2}, 3_{B} that define a cavity 3_{C}. Access to the cavity 3_{C} is permitted by one or more openings 3_{O} (see, e.g., FIG. 16A) formed by the one or more panels 3_{F}, 3_{T}, 3_{R}, 3_{S1}, 3_{S2}. A door 3_{D} (see, e.g., FIG. 16A) is attached to one or more of the panels 3_{F}, 3_{T}, 3_{R}, 3_{S1}, 3_{S2} and is arrangable in one of a closed orientation (see, e.g., FIG. 16B) and an open orientation (see, e.g., FIG. 16A) in order to respectively deny access to or permit access to the one or more openings 3_{O}. When the door 3_{D} is arranged in an open orientation (see, e.g., FIG. 16A), the pillow 1 may be inserted through the opening 3_{O} (see, e.g., FIG. 16A) for arrangement within the cavity 3_{C} of the housing 3 and upon the panel 3_{B} (see, e.g., FIG. 18) of the housing 3. The cavity 3_{C} of the housing 3 may provide a rest area whereby the animalia may not be free to leave the assembly 300 at its convenience depending on the closed orientation of the door 3_{D} or the open orientation of the door 3_{D}. When the door 3_{D} is in the open orientation, the animalia may enter or exit the cavity 3_{C} of the housing 3 by way of the one or more openings 3_{O}. When the door 3_{D} is in the closed orientation, the animalia may not enter or exit the cavity 3_{C} of the housing 3 by way of the one or more openings 3_{O}. The pan 2 may be selectively interfaced with a panel 3_{B} of the housing 3 (as seen at, e.g., FIGS. 16A-16B) prior to arrangement of the housing 3 upon the support portion 414 of the container 400. The pan 2 may contain or capture, for example: food, water, urine, feces, vomit, or other bodily fluids. Furthermore, in some configurations, the pan 2 and the housing 3 may be contained within the container 400 when the support portion 414 is arranged in a stowed orientation relative the base portion 412; however, prior to arranging the support portion 414 in the stowed orientation relative the base portion 412: (1) the pillow 1 should be removed from the cavity 3_{C} of the housing 3; and (2) the housing 3 should be arranged in a collapsed orientation (not shown).

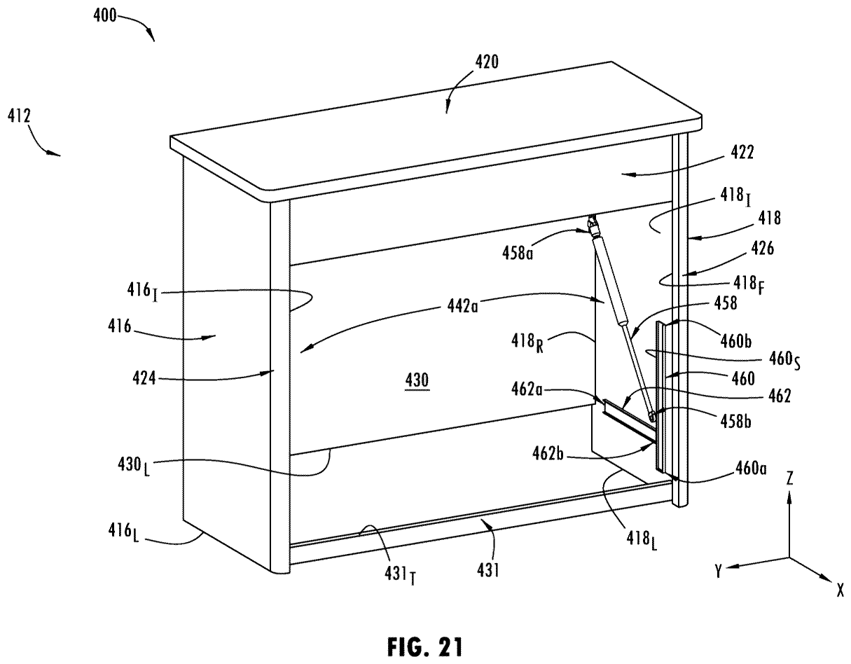

Referring now to FIGS. 19-21, an exemplary configuration of the base portion 412 of the container 400 is described. The base portion 412 includes a first leg member 416, a second leg member 418, a roof panel 420, and a shelf panel or drawer 422. The base portion 412 may also optionally include: a first leg member trim panel 424; a second leg member trim panel 426; a rear trim panel 430 (see, e.g., FIGS. 20 and 21); and a toe kick member 431. The members and panels 416-431 that form the base portion 412 may be connected with one or more fasteners (e.g., dowels, nails, screws, washers), adhesive, or the like; in some examples, the one or more fasteners may include one or more cam lock nuts F₁ (see, e.g., FIG. 24) and one or more cam screws F₂ (see, e.g., FIG. 25) for joining a first panel P₁ (see, e.g., FIGS. 26-27) of the members and panels 416-431 that form the base portion 412 to a second panel P₂ (see, e.g., FIGS. 26-27) of the members and panels 416-431 that form the base portion 412. As such, the base portion 412 may be a ready-to-assemble (RTA) furniture component that may be assembled by a user rather than assembled by a furniture manufacturer.

If one or more cam nuts F₁ and one or more cam screws F₂ are utilized for assembling the base portion 412, the base portion 412 may be assembled as follows. For example, as seen at FIG. 26, a cam nut F₁ may be rotatably-disposed within a cam nut-receiving bore P_{B1} of a first member/panel P₁ of the members/panels 416-431 of the base portion 412, and a cam screw F₂ may be threadingly-secured within a threaded bore P_{B2} (see, e.g., FIG. 27) formed by a second member/panel P₂ of the members/panels 416-431 of the base portion 412. In order to connect the first member/panel P₁ (that includes the one or more cam nuts F₁) to the second member/panel P₂ (that includes the one or more cam screws F₂), the cam screw F₂ is axially-aligned with (see, e.g., FIG. 26) a cam nut bore access passageway bore P_{B3} (see, e.g., FIG. 26) that is formed by the first member/panel P₁ and then the cam screw F₂ is inserted into (see, e.g., FIG. 27) the cam nut bore access passageway bore P_{B3}. As seen at FIGS. 26-27, the cam nut bore access passageway bore P_{B3} is substantially perpendicular with respect to the cam nut-receiving bore P_{B1}. Then, as seen at FIG. 27, once a distal end F_{2D} of the cam screw F₂ is interfaced with a proximal end F_{1P} of the cam 30 nut F₁, a user utilizes a tool T (see, e.g., FIG. 27), such as, a screwdriver, in order to engage a distal end F_{1D} of the cam nut F₁ to rotate R the cam nut F₁. Rotation R of the cam nut F₁ results in the application of a pulling force or a drawing force X (that is orthogonal to a rotational axis A_{R}-A_{R} of the cam nut F₁) applied to the cam screw F₂. As a result, because a proximal end F_{2P} of the cam screw F₂ is threadingly-secured to the second panel P₂, an outer surface P_{2S} of the second panel P₂ (where the cam screw F₂ extends therefrom) is drawn into close or tight engagement with an outer surface P_{1S} of the first panel P₁ (that provides access to the cam nut bore access passageway bore P_{B3}).

The members/panels 416-431 of the base portion 412 of the container 400 are connected in a substantially similar manner as described above with respect to the members/panels 16-30 of the base portion 12 of the container 10 as seen at FIG. 3. Accordingly, for purposes of brevity, the exemplary connection of the members/panels 416-431 of the base portion 412 of the container 400 is not described here.

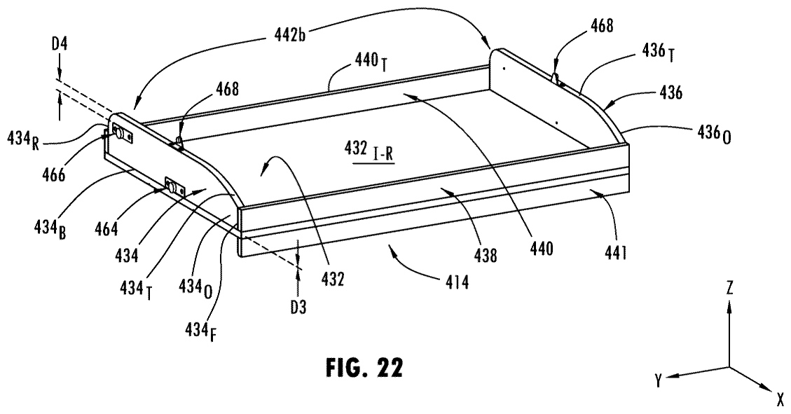

Referring also to FIGS. 19-20 and 22, an exemplary configuration of the support portion 414 of the container 400 is described. The support portion 414 includes a support panel 432, a first side panel 434 (see, e.g., FIGS. 20 and 22), a second side panel 436 (see, e.g., FIGS. 20 and 22), a first end panel 438 (see, e.g., FIGS. 20 and 22), and a second end panel 440 (see, e.g., FIGS. 20 and 22). The support portion 414 also includes a toe kick leg member 441. The members and panels 432-441 that form the support portion 414 may be connected with one or more fasteners (e.g., dowels, nails, screws, washers), adhesive, or the like (not shown); in some examples, the one or more fasteners may include one or more cam lock nuts F₁ (see, e.g., FIG. 24) and one or more cam screws F₂ (see, e.g., FIG. 25) for joining a first panel P₁ (see, e.g., FIGS. 26-27) of the members and panels 432-441 that form the support portion 414 to a second panel P₂ (see, e.g., FIGS. 26-27) of the members and panels 432-441 that form the support portion 414. As such, the support portion 414 may be a ready-to-assemble (RTA) furniture component that may be assembled by a user rather than assembled by a furniture manufacturer.

If one or more cam nuts F₁ and one or more cam screws F₂ are utilized for assembling the support portion 414, the support portion 414 may be assembled as follows. For example, as seen at FIG. 26, a cam nut F₁ may be rotatably-disposed within a cam nut-receiving bore P_{B1} of a first member/panel P₁ of the members/panels 416-431 of the base portion 412, and a cam screw F₂ may be threadingly-secured within a threaded bore P_{B2} (see, e.g., FIG. 27) formed by a second member/panel P₂ of the members/panels 432-441 of the support portion 414. In order to connect the first member/panel P₁ (that includes the one or more cam nuts F₁) to the second member/panel P₂ (that includes the one or more cam screws F₂), the cam screw F₂ is axially-aligned with (see, e.g., FIG. 26) a cam nut bore access passageway bore P_{B3} (see, e.g., FIG. 26) that is formed by the first member/panel P₁ and then the cam screw F₂ is inserted into (see, e.g., FIG. 27) the cam nut bore access passageway bore P_{B3}. As seen at FIGS. 26-27, the cam nut bore access passageway bore P_{B3} is substantially perpendicular with respect to the cam nut-receiving bore P_{B1}. As seen at FIG. 27, once a distal end F_{2D} of the cam screw F₂ is interfaced with a proximal end F_{1P} of the cam nut F₁, a user utilizes a tool T (see, e.g., FIG. 27), such as, a screwdriver, in order to engage a distal end F_{1D} of the cam nut F₁ to rotate R the cam nut F₁. Rotation R of the cam nut F₁ results in the application of a pulling force or a drawing force X (that is orthogonal to a rotations axis A_{R}-A_{R} of the cam nut F₁) to the cam screw F₂. As a result, an outer surface P_{2S} of the second panel P₂ that includes the cam screw F₂ extending therefrom is drawn into close or tight engagement with an outer surface P_{1S} of the first panel P₁ that provides access to the cam nut bore access passageway bore P_{B3}.

The members/panels 432-441 of the support portion 414 of the container 400 are connected in a substantially similar manner as described above with respect to the members/panels 32-40 of the support portion 14 of the container 10 as seen at FIG. 3. Accordingly, for purposes of brevity, the exemplary connection of the members/panels 432-441 of support portion 414 of the container 400 is not described here.

Referring to FIG. 20, upon connecting the first side panel 434, the second side panel 436, the first end panel 438, and the second end panel 440 to the inner surface 4321 of the of the support panel 432 for forming the support portion 414, the panels 434, 436, 438, 440 may collectively define an item retaining barrier 454. With further reference to FIG. 20, in some configurations, the first leg member 416, the second leg member 418, and the shelf panel or drawer 422 may collectively form a support portion-receiving cavity 456 having a width dimension W₄₅₆ and a height dimension H₄₅₆. The width dimension W₄₅₆ extends between opposing inner side surfaces, 416_{I}, 418_{I} of the first leg member 416 and the second leg member 418. The height dimension H₄₅₆ extends between a lower side surface 422_{L} of the shelf panel or drawer 422 and a lower surface 416_{L} (see, e.g., FIGS. 20-21), 418_{L} (see, e.g., FIG. 21) of each of the first leg member 416 and the second leg member 418.

With reference to FIGS. 20, 23, and 23A-23F, the container 400 also includes at least one damper 442 that is connected to or supported by one or both of the base portion 412 and the support portion 414. The at least one damper 442 may be any structure or assembly that provides for resistance and/or assistance of movement, such as, for example, a combination of one or more of a hydraulic arm 458 (see, e.g., FIGS. 20, 21, 23, and 23A-23F), a wheel guide track 460, 462 (see, e.g., FIGS. 20, 21, 23, and 23A-23F), a bracket-mounted-wheel 464, 466 (see, e.g., FIGS. 22, 23, and 23A-23F), a hydraulic arm bracket 468 (see, e.g., FIGS. 20, 22, 23, and 23A-23F), a spring, a cable, a pulley, and/or a weight.

In some instances, the at least one damper 442 may resist (but not prevent) movement of the support portion 414 from the stowed orientation (see, e.g., FIGS. 19 and 23F) to the deployed orientation (see, e.g., FIGS. 20 and 23A). Additionally, or, alternatively, the at least one damper 442 may assist (but not provide sufficient force for) movement of the support portion 414 from the deployed orientation (see, e.g., FIGS. 20 and 23A) back to the stowed orientation (see, e.g., FIGS. 19 and 23F).

In some implementations, when the support portion 414 is arranged in the stowed orientation relative the base portion 412, two dampers 442 may provide a stowed orientation tension that ranges between approximately thirty-eight (38) pounds/one-hundred-and-sixty-nine (169) Newtons to forty-two (42) pounds/one-hundred-and-eight-six (186) Newtons. In other implementations, when the support portion 414 is arranged in a 90°-full-open/deployed orientation relative the base portion 412, the one or more dampers 442 may provide a deployed orientation tension that ranges between approximately forty (40) pounds/one-hundred-and-seventy-seven (177) Newtons to forty-four (44) pounds/one-hundred-and-ninety-five (195) Newtons.

In other implementations, when the support portion 414 is arranged in the stowed orientation relative the base portion 412, the two dampers 442 may provide a stowed orientation tension that ranges between approximately eighteen (18) pounds/eighty (80) Newtons to twenty-two (22) pounds/ninety-eight (98) Newtons. In other implementations, when the support portion 414 is arranged in a 90°-full-open/deployed orientation relative the base portion 412, the one or more dampers 442 may provide a deployed orientation tension that ranges between approximately twenty-four (24) pounds/one-hundred-and-six (106) Newtons to twenty-eight (28) pounds/one-hundred-and-twenty-five (125) Newtons.

The damper 442 may be further characterized as having a plurality of portions 442a (see, e.g., FIG. 21), 442b (see, e.g., FIG. 22). As seen at FIG. 21, in some implementations, a first portion 442a of the damper 442 is connected to or supported by the base portion 412. Referring to FIG. 22, in other implementations, a second portion 442b of the damper 442 is connected to or supported by the support portion 414.

As seen at FIG. 21, in some configurations, the first portion 442a of the at least one damper 442 includes a hydraulic arm 458, a first wheel guide track 460 (that extends in a direction according to the arrow Z of an X-Y-Z Cartesian Coordinate System), and a second wheel guide track 462 (that extends in a direction according to the arrow X of an X-Y-Z Cartesian Coordinate System). As seen at FIG. 22, in other configurations, the second portion 442b of the at least one damper 442 includes a first bracket-mounted-wheel 464, a second bracket-mounted-wheel 466, and hydraulic arm bracket 468.

With reference to FIG. 20, in some implementations, the container 400 includes: (1) a first damper 442 connecting the first leg member 416 of the base portion 412 to the first side panel 434 of the support portion 414; and (2) a second damper 442 connecting the second leg member 418 of the base portion 412 to the second side panel 436 of the support portion 414. As seen at FIGS. 20 and 21, the second damper 442 of the container 400 is shown (whereas the first damper 442 of the container 400 is partially obstructed from view by the first leg member 416).

Referring to FIG. 21, exemplary aspects of the first portion 442a of the second damper 442 of the at least one damper 442 connected to or supported by the second leg member 418 is shown. Although the first portion 442a of the first damper 442 of the at least one damper 442 is not shown at FIGS. 20-21 (because it is partially obstructed from view by the first leg member 416), the first portion 442a of the first damper 442 of the at least one damper 442 is connected to or supported by the first leg member 416 in a substantially similar manner as the first portion 442a of the second damper 442 with respect to the second leg member 418.

In some instances as seen at, for example, FIG. 21, the hydraulic arm 458 includes a first end 458a and a second end 458b. The first end 458a of the hydraulic arm 458 is connected to the inner side surface 418_{I} of the second leg member 418 of the base portion 412.

With continued reference to FIG. 21, the first wheel guide track 460 is connected to the inner side surface 418_{I} of the second leg member 418 of the base portion 412. In some implementations, the first wheel guide track 460 is arranged near and spaced apart from a front surface 418_{F} of the second leg member 418 (that is opposite a rear surface 418_{R} of the second leg member 418) at a distance D1 (see, e.g., FIG. 23). The first wheel guide track extends along the front surface 418_{F} of the second leg member 418 in a direction according to the arrow Z of an X-Y-Z Cartesian Coordinate System.

The second wheel guide track 462 is connected to the inner side surface 418_{I} of the second leg member 418 of the base portion 412. In some implementations, the second wheel guide track 462 is arranged near and spaced apart from a lower end 418_{L} of the second leg member 418 (that is opposite an upper end of the second leg member 418) at a distance D2 (see, e.g., FIG. 23). The second wheel guide track 462 extends along the lower end 418_{L} of the second leg member 418 in a direction according to the arrow X of the X-Y-Z Cartesian Coordinate System.

Referring to FIG. 21, the first wheel guide track 460 includes a first end 460a and a second end 460b. With continued reference to FIG. 21, the second wheel guide track 462 includes a first end 462a and a second end 462b.

With reference to FIGS. 21, 23, and 23A-23F, the first wheel guide track 460 and the second wheel guide track 462 are arranged in a perpendicular configuration. Furthermore, in some configurations, the second end 462b of the second wheel guide track 462 is arranged near the front surface 418_{F} of the second leg member 418 may be disposed adjacent a longitudinal side surface 460_{S} of the first wheel guide track 460 that is arranged closer to the rear surface 418_{R} of the second leg member 418. Yet even further, the first wheel guide track 460 may include a length that is greater than a length of the second wheel guide track 462.

Referring to FIG. 22, exemplary aspects of the second portion 442b of the first damper 442 of the at least one damper 442 connected to the first leg member 416 is shown. Although the second portion 442b of the second damper 442 of the at least one damper 442 is not shown at FIGS. 20-21 (because it is partially obstructed from view by the second leg member 418), the second portion 442b of the second damper 442 of the at least one damper 442 is connected to the second leg member 418 in a substantially similar manner as the second portion 442b of the first damper 442 with respect to the first leg member 416.

In some instances as seen at, for example, FIG. 22, the first bracket-mounted wheel 464 is connected to the outer side surface 434_{O} of the first side panel 434 of the support portion 414. In some implementations, the first bracket-mounted wheel 464 is arranged near the bottom surface 434_{B} of the first side panel 434 of the support portion 414 (that is opposite the top surface 434_{T} of the first side panel 434 of the support portion 414) at a distance D3 (see, e.g., FIG. 22). Furthermore, the first bracket-mounted wheel 464 is arranged substantially between or substantially at an equal distance from a rear surface 434_{R} of the first side panel 434 of the support portion 414 and a front surface 434_{F} of the first side panel 434 of the support portion 414. The first bracket-mounted wheel 464 extends along the bottom surface 434_{B} of the first side panel 434 of the support portion 414 in a direction according to the arrow X of the X-Y-Z Cartesian Coordinate System (when the support portion 414 is arranged in the deployed orientation as seen at FIG. 22).

In some examples, the second bracket-mounted wheel 466 is connected to the outer side surface 434_{O} of the first side panel 434 of the support portion 414. In some implementations, the second bracket-mounted wheel 466 is arranged near and spaced apart from a top surface 434_{T} of the first side panel 434 of the support portion 414 (that is opposite a bottom surface 434_{B} of the first side panel 434 of the support portion 414) at a distance D4 (see, e.g., FIG. 22). Furthermore, the second bracket-mounted wheel 466 is arranged near the rear surface 434_{R} of the first side panel 434 of the support portion 414 (that is opposite the front surface 434_{F} of the first side panel 434 of the support portion 414). The second bracket-mounted wheel 466 extends along the top surface 434_{T} of the first side panel 434 of the support portion 414 in a direction according to the arrow X of the X-Y-Z Cartesian Coordinate System (when the support portion 414 is arranged in the deployed orientation as seen at FIG. 22).

With reference to FIGS. 22, 23, and 23A-23F, although both of the first bracket-mounted wheel 464 and the second bracket-mounted wheel 466 extend a direction according to the arrow X of the X-Y-Z Cartesian Coordinate System (when the support portion 414 is arranged in the deployed orientation as seen at FIG. 22), the first bracket-mounted wheel 464 and the second bracket-mounted wheel 466 are arranged in parallel to one another. In other words, the first bracket-mounted wheel 464 and the second bracket-mounted wheel 466 are spaced apart from one another according to a distance D5 (see, e.g., FIG. 23) in a direction according to the arrow Z of the X-Y-Z Cartesian Coordinate System (when the support portion 414 is arranged in the deployed orientation as seen at FIG. 22).

The hydraulic arm bracket 468 is connected to the top surface 434_{T} of the first side panel 434 of the support portion 414. In some implementations the hydraulic arm bracket 468 is arranged substantially between or substantially at an equal distance from the rear surface 434_{R} of the first side panel 434 of the support portion 414 and the front surface 434_{F} of the first side panel 434 of the support portion 414. In some instances, the hydraulic arm bracket 468 may be axially aligned with the first bracket-mounted wheel 464 a direction according to the arrow Z of the X-Y-Z Cartesian Coordinate System.

Referring to FIGS. 20, 23, and 23A-23F, an exemplary connection configuration of the first portion 442a of the at least one damper 442 to the second portion 442b of the at least one damper 442 is shown. In some configurations, the first portion 442a of the at least one damper 442 is connected to the second portion 442b of the at least one damper 442 by: (1) as seen at FIGS. 20 and 23, connecting a second end 458b of the hydraulic arm 458 of the first portion 442a of the at least one damper 442 to the hydraulic arm bracket 468 of the second portion 442b of the at least one damper 442; (2) as seen at FIGS. 23 and 23A-23F, arranging the first bracket-mounted wheel 464 of the second portion 442b of the at least one damper 442 within the first wheel guide track 460 of the first portion 442a of the at least one damper 442; and (3) as seen at FIGS. 23 and 23A-23F, arranging the second bracket-mounted wheel 466 of the second portion 442b of the at least one damper 442 within the second wheel guide track 462 of the first portion 442a of the at least one damper 442.

Unlike the configuration of the container 10 as seen at FIGS. 1-2 that includes a first pivot pin 50 (see, e.g., FIG. 2) and a second pivot pin 52 (see, e.g., FIGS. 1-2) for rotatably-connecting the support portion 14 to the base portion 12 in order to permit the support portion 14 to be arranged in one of the stowed orientation (see, e.g., FIG. 1) and the deployed orientation (see, e.g., FIG. 2) relative the base portion 12 along a fixed pivot axis A-A (see, e.g., FIG. 1), the container 400 is permitted to pivot in a different manner (i.e., along a first non-fixed pivot axis A1 as seen at FIG. 23 and a second non-fixed pivot axis as seen at A2 as seen at FIG. 23) as a result of the configuration of the at least one damper 442. In other words, the container 400 does not include one fixed axis of rotation (as defined by the fixed pivot axis A-A extending through the first and second pivot pins 50 and 52 arranged in the pivot pin passages 16_{P}, 34_{P} and 18_{P}, 36_{P}) of the support portion 414 relative the base portion 412, but, rather, more than one axis of rotation (e.g., the first non-fixed pivot axis A1 and the second non-fixed pivot axis as seen at A2) that are arranged in a non-fixed manner. Accordingly, the at least one damper 442 provides more than one non-fixed axis of rotation that permits the support portion 414 to be arranged in one of the stowed orientation and the deployed orientation.

Referring now to FIGS. 23 and 23A-23F, the more than one non-fixed axis of rotation A1, A2 provided by the at least one damper 442 includes: (1) a first non-fixed axis of rotation A1 (according to the arrow Y of the X-Y-Z Cartesian Coordinate System) that extends through the first bracket-mounted wheel 464 of the second portion 442b of the at least one damper 442; and (2) a second non-fixed axis of rotation A2 (according to the arrow Y of the X-Y-Z Cartesian Coordinate System) that extends through the second bracket-mounted wheel 466 of the second portion 442b of the at least one damper 442. The first non-fixed axis of rotation A1 that extends through the first bracket-mounted wheel 464 of the second portion 442b of the at least one damper 442 is movable according to the arrow Z of the X-Y-Z Cartesian Coordinate System within the first wheel guide track 460 of the first portion 442a of the at least one damper 442. The second non-fixed axis of rotation A2 that extends through the second bracket-mounted wheel 466 of the second portion 442b of the at least one damper 442 is movable according to the arrow X of the X-Y-Z Cartesian Coordinate System within the second wheel guide track 462 of the first portion 442a of the at least one damper 442.

As a result of the more than one non-fixed axis of rotation provided by the at least one damper 442, a lower corner or lower edge 414_{L} of the support portion 414 travels along an arced path A as the support portion 414 pivots to/from a deployed orientation (see, e.g., FIG. 23A) and a stowed orientation (see, e.g., FIG. 23F) relative the base portion 412. The arced path A is not defined by radius extending from a center point due to the at least one damper 442 providing more than one non-fixed axis of rotation A1, A2.

Furthermore, although the at least one damper 442 provides more than one non-fixed axis of rotation A1, A2, the second bracket-mounted wheel 466 of the second portion 442b of the at least one damper 442 provides a fixed axis of rotation during a portion of the movement of the first bracket-mounted wheel 464 of the second portion 442b of the at least one damper 442. For example, with reference to FIG. 23A, when the support portion 414 is arranged in the deployed orientation relative the base portion 412, the second bracket-mounted wheel 466 does not move within the second wheel guide track 462 as the first bracket-mounted wheel 464 moves within and along a portion of a length the first wheel guide track 460 extending from the first end 460a of the first wheel guide track 460 as seen at FIGS. 23A-23C. However, once the first bracket-mounted wheel 464 is aligned (according to the arrow X of the X-Y-Z Cartesian Coordinate System) with the second wheel guide track 462 (as seen at, e.g., FIG. 23C), the second bracket-mounted wheel 466 then moves (according to the arrow X of the X-Y-Z Cartesian Coordinate System) within the second wheel guide track 462 as seen at FIGS. 23C-23F toward the first end 460a of the first wheel guide track 460. Although a progressive movement of the support portion 414 from the deployed orientation (see, e.g., FIG. 23A) to the stowed orientation (see, e.g., FIG. 23F) relative the base portion 412 is shown at FIGS. 23A-23F and described above, movement of support portion 414 relative the base portion 412 from the stowed orientation (see, e.g., FIG. 23F) to the deployed orientation (see, e.g., FIG. 23A) also occurs but in a reverse order.

Referring to FIG. 23, aspects of the toe kick leg member 441 are now described. The toe kick leg member 441 extends from the outer surface 432_{O} of the support panel 432 of the support portion 414 at a distance D6. Accordingly, when the support portion 414 is arranged in the deployed orientation (see, e.g., FIG. 23A) relative the base portion 412, the toe kick leg member 441 contacts a ground surface G such that the outer surface 432_{O} of the support panel 432 of the support portion 414 is arranged away from the ground surface G at the distance D6. The spacing of the outer surface 432_{O} of the support panel 432 of the support portion 414 away from the ground surface G at the distance D6 permits a ‘arced pivot clearance’ for the lower corner or lower edge 414_{L} of the support portion 414 away from the ground surface G in order to permit the lower edge 414_{L} of the support portion 414 to travel along the arced path A as the support portion 414 pivots to/from a deployed orientation (see, e.g., FIG. 23A) and a stowed orientation (see, e.g., FIG. 23F) relative the base portion 412.

With continued reference to FIG. 23, when the support portion 414 is arranged in the deployed orientation relative the base portion 412, the outer surface 432_{O} of the support panel 432 of the support portion 414 is disposed adjacent and supported by a top surface 431_{T} (see also, e.g., FIG. 21) of the toe kick member 431 of the base portion 412. Yet even further, when the support portion 414 is arranged in the deployed orientation relative the base portion 412, a top surface 440_{T} (see also, e.g., FIG. 22) of the second end panel 440 of the support portion 414 may be arranged opposite or disposed adjacent a lower surface 430_{L} (see also, e.g., FIG. 21) of the rear trim panel 430 of the base portion 412.

In view of the arrangement of the support portion 414 relative the ground surface G and the base portion 412 when the support portion 414 is arranged in the deployed orientation relative the base portion 412, the support portion 414 defines three contacts points being: (1) the toe kick leg member 441 disposed adjacent the ground surface G; (2) the outer surface 432_{O} of the support panel 432 disposed adjacent the top surface 431_{T} of the toe kick member 431 of the base portion 412; and (3) the top surface 440_{T} of the second end panel 440 disposed adjacent the lower surface 430_{L} of the rear trim panel 430 of the base portion 412.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

Further, it should be understood that any directions or reference frames in the preceding description are merely relative directions or movements. For example, any references to “up” and “down” or “above” or “below” are merely descriptive of the relative position or movement of the related elements.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A container (10; 400) comprising:
a base portion (12; 412); and
a support portion (14; 414) movably-connected to the base portion (12; 412), wherein each of the base portion (12; 412) and the support portion (14; 414) include a plurality of panels and members (16-30; 416-431, 32-40; 432-441),
wherein the support portion (14; 414) includes an item retaining barrier (54; 454),
wherein the base portion (12, 412) forms a support portion receiving cavity (56; 456) configured for receiving the support portion (14; 414).

2. The container (10; 400) of claim 1, wherein the plurality of panels and members (16-30; 416-431) forming the base portion (12; 412) include at least a first leg member (16; 416), a second leg member (18; 418), and a shelf panel (22; 422), wherein the first leg member (16; 416), the second leg member (18; 418), and the shelf panel (22; 422) form the support portion receiving cavity (56; 456).

3. The container (10; 400) of claim 2, wherein:
a first side surface (22_{S1}; 422_{S1}) of the shelf panel (22; 422) is secured to an inner side surface (16_{I}; 416_{I}) of the first leg member (16; 416); and
a second side surface (22_{S2}; 422_{S2}) of the shelf panel (22; 422) is secured to an inner side surface (18_{I}; 418_{I}) of the second leg member (18; 418),
wherein the support portion receiving cavity (56; 456) is formed by:
a lower side surface (22_{SL}; 422_{SL}) of the shelf panel (22; 422);
a portion of the inner side surface (16_{I}; 416_{I}) of the first leg member (16; 416) extending away from the lower side surface (22_{SL}; 422_{SL}) of the shelf panel (22; 422); and
a portion of the inner side surface (18_{I}; 418_{I}) of the second leg member (18; 418) extending away from the lower side surface (22_{SL}; 422_{SL}) of the shelf panel (22; 422).

4. The container (10; 400) of claim 2, wherein the plurality of panels and members (16-30; 416-431) forming the base portion (12; 412) further includes a roof panel (20; 420), wherein:
an upper surface (16_{U}; 416_{U}) of the first leg member (16; 416) is secured to a lower surface (20_{L}; 420_{L}) of the roof panel (20; 420) near a first side surface (20_{S1}; 420_{S1}) of the roof panel (20; 420);
an upper surface (18_{U}; 418_{U}) of the second leg member (18; 418) is secured to the lower surface (20_{L}; 420_{L}) of the roof panel (20; 420) near a second side surface (20_{S2}; 420_{S2}) of the roof panel (20; 420) that is opposite the first side surface (20_{S1}; 420_{S1}) of the roof panel (20; 420).

5. The container (10; 400) of claim 1, wherein the plurality of panels and members (32-40; 432-441) forming the support portion (12; 412) include at least a support panel (32; 432) and at least one panel (34-40; 432-441) that forms the item retaining barrier (54; 454) connected to and extending from an inner surface (321; 4321) of the support panel (32; 432) at a height (H₅₄; H₄₅₄).

6. The container (10; 400) of claim 5, wherein the at least one panel (34-40; 434-440) that forms the item retaining barrier (54; 454) includes:
a first side panel (34; 423) having a lower surface (34_{L}; 434_{L}) that is secured to the inner surface (32_{I}; 432_{I}) of the support panel (32; 432) near a first side surface (32_{S1}; 432_{S1}) of the support panel (32; 432);
a second side panel (36; 436) having a lower surface (36_{L}; 436_{L}) that is secured to the inner surface (32_{I}; 432_{I}) of the support panel (32; 432) near a second side surface (32_{S2}; 432_{S2}) of the support panel (32; 432);
a first end panel (38; 438) having a lower surface (38_{L}; 438_{L}) that is secured to the inner surface (32_{I}; 432_{I}) of the support panel (32; 432) near a third side surface (32_{S3}; 432_{S3}) of the support panel (32; 432); and
a second end panel (40; 440) having a lower surface (40_{L}; 440_{L}) that is secured to the inner surface (32_{I}; 432_{I}) of the support panel (32; 432) near a fourth side surface (32_{S4}; 432_{S4}) of the support panel (32; 432).

7. The container (10; 400) of claim 6, wherein the second side surface (32_{S2}; 432_{S2}) of the support panel (32; 432) is opposite the first side surface (32_{S1}; 432_{S1}) of the support panel (32; 432), wherein the third side surface (32_{S3}; 432_{S3}) of the support panel (32; 432) is connected to a first end of the first side surface (32_{S1}; 432_{S1}) of the support panel (32; 432) and a first end of the second side surface (32_{S2}; 432_{S2}) of the support panel (32; 432), wherein the fourth side surface (32_{S4}; 432_{S4}) of the support panel (32; 432) is opposite the third side surface (32_{S3}; 432_{S3}) of the support panel (32; 432), wherein the fourth side surface (32_{S4}; 432_{S4}) of the support panel (32; 432) is connected to a second end of the first side surface (32_{S1}; 432_{S1}) of the support panel (32; 432) and a second end of the second side surface (32_{S2}; 432_{S2}) of the support panel (32; 432).

8. The container (10) of claim 1 further comprising:
a first pivot pin (50) and a second pivot pin (52) that rotatably-connect the support portion (14) to the base portion (12) for permitting the support portion (14) to be arranged in one of:
a stowed orientation relative the base portion (12); and
a deployed orientation relative the base portion (12).

9. The container (10) of claim 8, wherein the first pivot pin (50) extends through and is arranged within:
a pivot pin passage (16_{P}) formed near a lower end (16_{L}) of a member (16) of the plurality of panels and members (16-30) of the base portion (12); and
a pivot pin passage (34_{P}) formed near a lower end (34_{L}) of a panel (34) of the plurality of panels and members (32-40) of the support portion (14),
wherein the second pivot pin (52) extends through and is arranged within:
a pivot pin passage (18_{P}) formed near a lower end (18_{L}) of another member (18) of the plurality of panels and members (16-30) of the base portion (12); and
a pivot pin passage (36_{P}) formed near a lower end (36_{L}) of another panel (36) of the plurality of panels and members (32-40) of the support portion (14).

10. The container (10; 400) of claim 1 further comprising:
at least one damper (42; 442) connected to one or both of the base portion (12; 412) and the support portion (14; 414) for one or both of:
resisting movement of the support portion (14; 414) relative the base portion (12; 412) in a first direction; and
assisting movement of the support portion (14; 414) relative the base portion (12; 412) in a second direction opposite the first direction.

11. The container (400) of claim 10, wherein the damper (442) includes:
a first portion (442a) connected to the base portion (412), wherein the first portion (442a) of the damper (442) includes:
a hydraulic arm (458) including a first end (458a) connected to the base portion (412);
a first wheel guide track (460) connected to the base portion (412); and
a second wheel guide track (462) connected to the base portion (412).

12. The container (400) of claim 11, wherein the second wheel guide track (462) is arranged substantially perpendicularly with respect to the first wheel guide track (460).

13. The container (400) of claim 12, wherein the damper (442) further includes:
a second portion (442b) connected to the support portion (414), wherein the second portion (442b) of the damper (442) includes:
a first bracket-mounted wheel (464) connected to the support portion (414), wherein the first bracket-mounted wheel (464) is movably-disposed within the first wheel guide track (460) of the first portion (442a) of the damper (442);
a second bracket-mounted wheel (466) connected to the support portion (414), wherein the second bracket-mounted wheel (466) is movably-disposed within the second wheel guide track (462) of the first portion (442a) of the damper (442); and
a hydraulic arm bracket (468) connected to the support portion (414), wherein the hydraulic arm bracket (468) is connected to a second end (458b) of the hydraulic arm (458) of the first portion (442a) of the damper (442).

14. The container (400) of claim 13, wherein the first bracket-mounted wheel (464) is movably-disposed within first wheel guide track (460) in a first direction (Z), wherein the second bracket-mounted wheel (466) is movably-disposed within second wheel guide track (462) in a second direction (X), wherein the first direction (Z) is substantially perpendicular to the second direction (X).

15. An assembly (100, 200, 300) including:
a container (10; 400) including a base portion (12; 412) and a support portion (14; 414) movably-connected to the base portion (12; 412), wherein each of the base portion (12; 412) and the support portion (14; 414) include a plurality of panels and members (16-30, 32-40; 416-431, 432-441), and wherein the support portion (14; 414) includes an item retaining barrier (54; 454), wherein the base portion (12; 412) forms a support portion receiving cavity (56; 456) configured for receiving the support portion (14; 414); and
at least one item (1, 2, 3) supported by the support portion (14; 414) and retained by the item retaining barrier (54; 454).

16. The assembly (100) of claim 15, wherein the at least one item (1, 2, 3) is a pillow (1).

17. The assembly (100) of claim 16, wherein the pillow is defined by a thickness (T₁) extending between a top surface (1_{ST}) of the pillow (1) and a bottom surface of the pillow (1), wherein the item retaining barrier (54; 454) of the support portion (14; 414) is defined by a height dimension (H₅₄; H₄₅₄) that is approximately equal to the thickness (T₁) of the pillow (1).

18. The assembly (200, 300) of claim 15, wherein the at least one item (1, 2, 3) is a knock-down housing (3).

19. The assembly (200, 300) of claim 18, wherein the knock-down housing (3) is defined by a collapsed orientation height (H₃′), wherein the item retaining barrier (54; 454) of the support portion (14; 414) is defined by a height dimension (H₅₄; H₄₅₄) that is approximately equal to the collapsed orientation height (H₃′) of the knock-down housing (3).

20. The assembly (200, 300) of claim 19, wherein the knock-down housing (3) is defined by an expanded orientation height (H₃), wherein the height dimension (H₅₄; H₄₅₄) of the item retaining barrier (54; 454) that is less than the expanded orientation height (H₃) of the knock-down housing (3).

21. The assembly (200, 300) of claim 15, wherein the at least one item (1, 2, 3) further includes a pan (2) interfaced with the knock-down housing (3).

22. The assembly (300) of claim 21, wherein the at least one item (1, 2, 3) further includes a pillow (1) interfaced with the knock-down housing (3).
